(19) United States
(12) Patent Application Publication
(10) Pub. No.: US 2017/0286965 A1
(43) Pub. Date: Oct. 5, 2017

(54) SYSTEM AND METHOD FOR TRACKING AND SECURING THE PURCHASE AND SALE OF CONTROLLED SUBSTANCE

(71) Applicant: Shield Compliance, LLC, Evanston, IL (US)

(72) Inventors: William Erwin, Santa Ana, CA (US); Noah P. Carey, Evanston, IL (US)

(73) Assignee: Shield Compliance, LLC, Evanston, IL (US)

(21) Appl. No.: 15/087,938

(22) Filed: Mar. 31, 2016

(51) Int. Cl. G06Q 20/40; G06Q 20/20; G06F 17/30

(52) U.S. Cl. CPC G06Q 20/40145; G06F 17/30864; G06Q 20/4016; G06Q 20/206

(57) ABSTRACT

A protection system for tracking and securing the purchase and sale of a controlled substance. The system includes a network and a database that stores information of a plurality of customers. The information regarding each customer is stored in an individual account, and the database further stores the information regarding government regulations on purchase and sale of the controlled substance. Also, the system includes a plurality of end user terminals to record transactions of the controlled substance. There is a server in communication with the database and the end user terminals over the network. The server includes a compliance reporting system. The compliance reporting system executes instructions to compare, in real time, information about one customer and the transaction to information stored in the database regarding the government regulations and the customer. In one embodiment, the system prevents the purchase of the controlled substance based on the comparison.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Although, under the law in several states of the United States it is legal to sell marijuana, the federal government still considers marijuana as a Schedule 1 controlled substance, which is illegal to possess. Additionally, federal regulations require financial institutions to assist the government in detecting criminal activity. Due to this conflict between state and federal law, most financial institutions do not offer service to the cannabis industry. Without access to bank accounts, most medical marijuana dispensaries operate in cash and often pay sales tax by hauling large bags of cash to government offices. This practice may pose a safety risk for the marijuana dispensary owners, as it often encourages crime and violence. Additionally, cash-only medical marijuana dispensaries are more difficult for the government to audit because these businesses do not have access to the same banking documents. By allowing marijuana dispensaries to have an access to different services provided by the financial institutes, the risk of robbery in the marijuana dispensaries can be decreased along with the probability of money-laundering via such dispensaries.

Furthermore, there is no database to track purchase of marijuana between different dispensaries. Also, there is no system to check the background information of a purchaser in real time as a transaction is occurring.

Therefore, there is a need for a centralized system and/or method for tracking and securing the purchase and sale of marijuana and provide regular compliance reports to federal government. Also, what is needed is a system and method to check the background of the purchaser in real-time before the purchase or sale of marijuana.

### SUMMARY

Briefly, and in general terms, various embodiments are directed to a protection system for tracking and securing the purchase and sale of controlled substance. This system may be used by the government, the financial institution, auditors, or the like to track information relating to cultivators, vendors, merchants and the customers. Also, the system can be used at stores, shops or dispensaries to verify a purchaser's background information before completing a transaction involving a controlled substance. In one embodiment, the protection system includes a network and a database that stores information of a plurality of customers. Information regarding each customer may be stored in an individual account. In one embodiment, the database further stores the information regarding government regulations on purchase and sale of the controlled substance. The protection system further includes a plurality of end user terminals at individual shops to record transactions of the controlled substance. The plurality of end user terminals are in communication with the database over the network. The protection system also includes a server in communication with the database and the end user terminals over a network (e.g., Internet, extranet, or intranet). In this embodiment, the server includes a compliance reporting system. The compliance reporting system executes instructions to allow or stop in real time the purchase of the controlled substance on one of the plurality of end user terminals at individual shops or dispensaries based on information stored in the database. The information may pertain to government regulations, background of purchaser or customer, or purchase history of customer.

In one embodiment, the end user terminal is a mobile device. The end user terminal may be a specialized point of sale system, a cash registrar, smart phone, tablet or other type of computer. In another embodiment, customer information maybe entered via a point of sale software application running on the end user terminal using a processor and a memory of the end user terminal. In some embodiment, the customer information may include a scan copy of an identification document or biometric information (e.g., fingerprints or eye scan). It has also been contemplated that the end user terminal is in communication with a camera or a scanner in order to capture identifying information of a customer, purchaser, or user of the system. For example, driver's license scanner may be used with the system.

In one embodiment, the information entered by the plurality of cultivator users, merchant users and customer users of the system are temporarily stored in a local database of the end user terminal. The local database of the end user terminal may be constantly or periodically synchronized with the database to store updated information from the end user terminal. Further, any computer at any location may be connected and synchronized with the database of the system. In one embodiment, both customer and cultivator information is stored in the local database and the main database. The customer and cultivator information may be used for comparison and identity verification as part of a due diligence program or any regulations.

In some embodiments, the protection system further includes an inventory database to store information regarding available inventories at the individual stores or dispensaries. The inventory database may be updated in real-time or periodically. Any inventory database would be designed to satisfy all state inventory tracking regulations pertaining to the sale, purchase and disposal of items.

In one embodiment, the compliance reporting system records every purchase and sale of the controlled substance made at the individual dispensaries and records the transactional information in the database. The compliance reporting system may access the transaction or purchase records of the individual dispensary for anti-money laundering reporting to the government. Reports may also be prepared and sent to investors of the dispensary or cultivator. In some embodiment, the compliance reporting system stores compliance rules for each individual dispensary. The compliance rules may include information regarding maximum dollar amount for transaction, maximum number of transaction per customer, or quantity limit of controlled substance. Any other rules or regulations may be stored and accessed by the compliance reporting system.

In one embodiment, the protection system also provides a stop on the sale of the controlled substance in real time in case any pre-requisite conditions required for the sale of the controlled substance are not fulfilled. Thus, the system may alert the merchant that the controlled substance should not be sold to a customer before finalizing a purchase of the controlled substance. The alert may be a message sent over the network to the end user terminal, an alert sent over the telephone, an alert sent via text message to a mobile phone, or the like. The alert may also be reported to a regulating facility, financial institute, law enforcement agency, or any organization that would have an interest preventing the illegal sale of a controlled substance. In certain embodiments, the system may prevent the transaction from occurring on the end user terminal. In some embodiments, if during a transaction of the controlled substance, the compliance reporting system determines that the dollar amount of the retail transaction is greater than the maximum dollar amount for the transaction, as specified in the compliance rules saved in the database, the compliance reporting system places the transaction on hold. In another embodiment, the compliance reporting system stops a transaction, if during the transaction of the controlled substance, the compliance reporting system determines that the age of the customer is less than 21 years or the dollar amount of the transaction is under a threshold level. In some embodiments, the compliance reporting system stops a transaction, if during the transaction of the controlled substance, the compliance reporting system determines that the retail quantity is greater than the purchase quantity limit of the controlled substance. In another embodiment, the compliance reporting system stops a transaction, if during the transaction of the controlled substance, the compliance reporting system determines that the time stamp is not within a predetermined range. Any pre-requisite condition may be stored in the database and checked before a transaction occurs at the dispensary.

In some embodiments, the compliance reporting system processes a transaction between a cultivator user and a merchant user, only when the identity of the cultivator user and the merchant user is verified by the compliance reporting system and the cultivator user's cannabis license is confirmed by the compliance reporting system. In some other embodiments, the compliance reporting system stops a transaction of controlled substance between a cultivator user and a merchant user, if during the transaction of the controlled substance, the compliance reporting system determines that the cultivator user or the merchant user is a non-US citizen. Any pre-requisite condition may be stored in the database and checked before allowing a transaction between a customer and merchant.

In another embodiment, the compliance reporting system stops or holds a transaction, if during the transaction of the controlled substance, the compliance reporting system determines that the payment to the cultivator user is requested out of the country.

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 discloses an exemplary system for tracking and securing the purchase and sale of controlled substances.

FIG. 2 discloses an example of a compliance rule setup screen.

FIG. 3 discloses an example of a user profile setup screen.

FIG. 4A discloses an example of a merchant profile setup screen.

FIG. 4B discloses an example of a merchant's dispensary setup screen.

FIG. 5 discloses an example of a customer profile setup screen.

FIG. 6 discloses an example of a screen shot of institution contact information of a suspicious activity report.

FIG. 7 discloses an example of a screen shot of law enforcement contact information of a suspicious activity report.

FIG. 8 discloses an example of a screen shot of information about the financial institute where the suspicious activity occurred, of a suspicious activity report.

FIG. 9 discloses an example of a screen shot of branch activity information of a suspicious activity report.

FIGS. 10-12 disclose example screen shots of a suspicious activity report.

FIGS. 13-20 disclose example screen shots of a regulator page.

FIGS. 21-22 disclose example screen shots of user login on a point of sale application.

FIG. 23 discloses an exemplary customer acknowledge screen shot on an end user terminal, during the sale of a controlled substance by the merchant.

FIG. 24 discloses an exemplary check-out screen shot on an end user terminal, during the sale of a controlled substance by the merchant.

FIG. 25 discloses an exemplary process flow diagram describing transactional steps to purchase a controlled substance.

FIG. 26 discloses an exemplary screen shot of a point of sale setup on an end user terminal.

### DETAILED DESCRIPTION

Each of the features and teachings disclosed herein can be utilized separately or in conjunction with other features and teachings to provide a system and method of implementing a computer-based, protection system for tracking and securing the purchase and sell of controlled substance. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particular representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

In the following description, certain specific details are set forth in order to provide a thorough understanding of various disclosed embodiments. However, one skilled in the relevant art will recognize that embodiments may be practiced without one or more of these specific details, or with other methods, components, materials, and the like. In other instances, well-known structures associated with servers, networks, displays, media handling, computers and/or processor/control systems have not been shown or described in detail to avoid unnecessarily obscuring descriptions of the embodiments.

Unless otherwise indicated, the functions described herein may be performed by executable code and instructions stored in a computer readable medium and running on one or more processor-based systems. However, state machines and/or hardwired electronic circuits may also be utilized. Further, with respect to the example processes described herein, not all of the process states need to be reached, nor do the states have to be performed in the illustrated order. Further, certain process states that are illustrated as being serially performed may be performed in parallel.

Similarly, unless expressly stated to be otherwise, while certain embodiments may refer to a Desktop Computer (“PC”) system or data device, other computer or electronic systems may be used as well, such as, without limitation, an interactive television, a network-enabled personal digital assistant (“PDA”), a network-enabled game console, a network-enabled entertainment device, a smart phone (e.g., with an operating system and on which a user may install applications) and the like.

In addition, while certain user inputs or gestures are described as being provided via phone key-presses, data entry via a keyboard, or by clicking a computer mouse or button, optionally, user inputs may be provided using other techniques, such as by voice or otherwise. The example screen layouts, appearance, and terminology as depicted and described herein, are intended to be illustrative and exemplary, and in no way limit the scope of the invention as claimed.

The terms, “for example,” “e.g.,” “in one/another aspect,” “in one/another scenario,” “in one/another version,” “in some configurations” “in some implementations,” “preferably,” “usually,” “typically,” “may,” and “optionally,” as used herein, are intended to be used to introduce non-limiting embodiments. Unless expressly stated otherwise, while certain references are made to certain example system components or services, other components and services may be used as well and/or the example components may be combined into fewer components and/or divided into further components. The terms, “member” and “user,” are used interchangeably. Members and users are subscribed to or enrolled in a network service or network of users.

The disclosed embodiments provide a centralized system and/or method for tracking and securing the purchase and sale of a controlled substance (e.g. marijuana, prescription drugs, or the like). Traditional tracking systems for purchase and sale of controlled substances do not provide the needed degrees of authorization and types of security features to different personnel (e.g., system administrators, vendor and/or cultivators, merchants, customers, or the like) as do the disclosed embodiments of the system described herein. The disclosed system provides the requisite high level of security needed for tracking the purchase and sale of controlled substances. The disclosed system also provides a stop on the sale of the controlled substance in real time in case any pre-requisite conditions required for the sale of the controlled substance are not fulfilled. Thus, the system will alert the merchant that the controlled substance should not be sold to a customer before finalizing a purchase of the controlled substance.

Generally, the different and various embodiments of the present disclosure cover a system and method to track the purchase and sale of a controlled substance. The various embodiments of the system and method of the present disclosure may also be used by the financial institutes to audit shops that sales controlled substances. Additionally, the system and method may be used to make sure that the compliance standards and state laws are adhered by the cultivators, merchants and the customers using the system.

In particular, the different embodiments of the system, as disclosed herein are designed to track the purchase and sale of a controlled substance like marijuana. However, a person skilled in the art will appreciate that the disclosed system can be used to track the purchase and sale of any other product (e.g., guns, prescription medicines, or the like) that is regulated by the government. One embodiment of the system includes a fully working point of sale (POS) and a server component running on Amazon Web Server (AWS). However, a person skilled in the art will appreciate that any server can be used in order to operate the system. In one embodiment, there are two major components in the system. The POS front-end runs on an end user terminal (e.g., tablet, mobile, laptop, or the like) and the back-end, i.e., the database and compliance reporting on a server AWS. A compliance reporting may run on the servers as well. The completed reports may be initiated via the front end, processed in the back-end and fed to the front end for display. The different embodiment of the disclosed system aims to ensure that all government regulations are adhered to by all parties in a marijuana dispensary. For example, in a marijuana dispensary, all parties may include the cultivators, the merchants and the customers monitored by the system. The system may also check to ensure that there is no money laundering through vendors and merchants.

In one embodiment, the POS terminal may run offline or when connected to the server. In one embodiment, the very first time a user starts the POS, the end user terminal must be connected to the server. A merchant profile is downloaded that contains among other attributes the user defined parameter, which may be used to determine the number of transactions the POS may process in offline mode and/or the number of hours it can run. This option will ensure that the POS works even if there is a loss of Internet connection. This parameter in the POS may ensure that offline mode is allowed only for a limited time. The POS may maintain a local database or use the local file system. The webservice on the end user terminal may periodically or constantly synchronize with the database on the server. The POS may use a driver license scanner to capture pertinent details of the customer. Cameras or other types of scanners may also be associated with the POS on end user terminal to capture information.

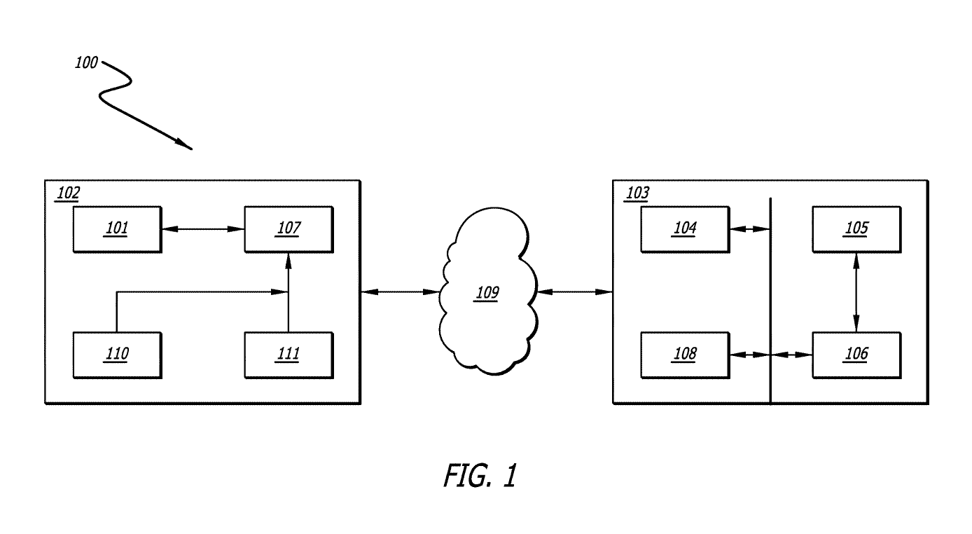

Referring now to the drawings, where like reference numerals denote like or corresponding parts throughout the drawings, and more particularly to FIG. 1, there is shown a system 100 for tracking and securing the purchase and sale of controlled substances (e.g. marijuana, prescription drugs, or the like). There are two major components in the system 100, an end user terminal 102 that runs as a POS application 101 on the end user terminal, and a back end system that may include a server 103. The end user terminal may be a mobile device, e.g., smart phone, tablet, laptop, or the like. The POS application 101 is capable of running offline or connected to the server 103 via a network. However, in one embodiment, the very first time a user (e.g., vendors and/or cultivators, merchants, customers, system administrators, or the like) starts the POS application 101 on the end user terminal 102, the end user terminal 102 may need to be connected to the server 103.

A network 109 connects the server 103 to the end user terminal 102, where the network 109 receives and processes requests from the plurality of users (e.g., vendors and/or cultivators, merchants, customers, system administrators). A plurality of standalone computers or servers can be connected to the network to access the server 103. The server 103 includes a database 104 that stores information on a plurality of cultivators, merchants, customers or the system administrators of the system 100. Each user (e.g., vendors and/or cultivators, merchants, customers, system administrators) of the system 100 may have an account in the database 104, and the information regarding each user is stored in the user's account in the database 104. In certain embodiment, the system administrators may have full access and editing privileges to all the accounts associated with the plurality of vendors and/or cultivators, merchants and the customers. The database 104 also stores information regarding government regulations on cultivation, purchase and sale of the controlled substance. Further, the database 104 stores the information regarding state laws on the purchase and sale of controlled substance.

The server 103 may further include a database of inventory called “inventory master” 108, separate from the database 104, although the inventory could be stored in database 104. The inventory master 108 stores the information regarding available inventories in a plurality of dispensaries in the system 100, that sell the controlled substance. Following is an exemplary table showing the information stored in the inventory master 108.

TABLE 1
Inventory Master.

| SCREEN | | |
|---|---|---|
| FIELD NAME | FIELD LENGTH & TYPE | COMMENTS |
| Item Number | 20 characters alpha | Mandatory |
| | numeric | |
| RFID Number | 50 characters alpha | Entered or scanned |
| | numeric | into the system |
| Item Name | 30 characters alpha | Mandatory |
| | numeric. | |
| Item Description | Text | |
| Amount THC | 9 digit numeric | |
| Price | 9 digit numeric | |

In some embodiments, the end user terminal 102 maintains a local database 107 outside server 103 to temporarily store the user information entered by the user via the POS application 101 running on the end user terminal 102. In some embodiment, the local database 107 may be a native iOS file system used to store user information on the end user terminal 102. In one embodiment, the local database 107 periodically or constantly synchronizes with the database 104 on the server 103 to store updated information from the user in the database 104. In some embodiments, the local database 107 may run off MS SQL 2012.

In certain embodiments, in order to access the system 100, users (e.g., cultivators, merchants, customers, system administrators) of the system 100 may register online by creating an online account, as shown in FIG. 3. In this example, it is assumed that the cultivator sells the controlled substance to the merchant who owns the dispensary. It is also assumed that the merchant sells the controlled substance to the customer. The controlled substance can be marijuana, guns, prescription medicines or any other product that is regulated by the government.

In one embodiment, a first time user of the system 100 starts the registering process by pressing an icon of the POS application 101 on the end user terminal 102. As soon as the POS application 101 is pressed, a user profile creation page may open. However, in one embodiment, a first time user of the system 100 cannot directly create an online account. In order to create an online account, a user of the system 100 first enters his/her information (e.g., username, password, email, full name, driver's license information, expiry date of the driving license, phone number, cannabis license number, or the like) at the profile creating page via the POS application 101 at end user terminal 102. Once the user information is received at the server 103 from the POS application 101 via the network 109, the system administrator reviews the information presented by the user and based on the information provided by the user during the registration, decides whether to accept his registration. If the system administrator is satisfied with the information presented by the user of the system 100 during the registration, the system administrator logs into the system 100 to create a user ID and a password for the user.

Different menu options (e.g., administration, reports) may appear on the top bar of the home screen of the POS application 101. By way of example only and not by way of limitation, a log-off button on the right and a “?” icon are present in home screen. If the “?” icon is pressed a website will open up with help text for the user. Under the administration option, the following options may appear in the dropdown menu. Non-administrator users cannot see these options. The options in the dropdown menu of the administrative options are following:

i) User Set-up

ii) Customer Profile

iii) Merchant Profile

iv) Inventory Master (only option will appear)

v) Vendor & Cultivator (only option will appear)

The system administrator can select the “user set-up” option from the drop down menu of the administrative tab to create the user profile using the information provided by the first time user. Next, the system administrator sends an email link to the user to set up a security question and password for their personal account. Once the user of the system 100 receives the email link, they set up a security question and password to login to the system 100. The user needs to follow password rules (e.g., password needs to be more than eight characters long, password must contain an upper case letter, a lower case letter, a number and a character, or the like) created by the system administrator during the creation of his password. Every registered user of the system 100 is required to change his password after a certain timeline (e.g., one month, six weeks, six months, or the like), as determined by the system administrator. However, if the user account setup is not completed properly by the user, the system 100 gives an error. In that case, the system administrator logs in and completes the setup for the user. By way of example only, the following is an exemplary table showing the information stored in the database 104 during the user profile creation.

TABLE 2
Information stored in the database during user profile creation.

| SCREEN | | |
|---|---|---|
| FIELD NAME | FIELD LENGTH & TYPE | COMMENTS |
| User Name | 20 characters alpha | Mandatory |
| | numeric | |
| User Type | Drop Down | 0 = Administrator with |
| | | Cloud Access. |
| | | 1 = Administrator |
| | | 2 = User |
| Email address | 30 characters alpha | Mandatory |
| | numeric. | |
| First Name | 20 characters alpha | Mandatory |
| | numeric | |
| Middle Name | 10 characters alpha | Mandatory |
| | numeric | |
| Last Name | 20 characters alpha | Mandatory |
| | numeric | |
| Driving License # | 20 characters alpha | Mandatory |
| | numeric | |
| State | 2 characters alpha numeric | Mandatory |
| Expiry Date | Date | Mandatory |
| Phone 1 | 10 characters alpha | Mandatory |
| | numeric | |
| Cannabis License | 10 characters alpha | |
| Number | numeric | |

Once registered, a user can upload documents (e.g., scanned copy of the driver's license or any other government issued ID, recent photograph, scanned copy of the cannabis license, or the like) to the server 103. The server 103 saves the uploaded documents in the user account that is saved in the database 104 of the server 103. The documents of the user saved in the database 104 can be used by the system 100 to verify and ensure that all government regulations are adhered by the cultivators, merchants and the customers who are using the system 100 to purchase and sell a controlled substance. The end user terminal 102 may use a scanner 110 or camera device 111 attached thereto to the end user terminal 102 to capture pertinent details of the user documents to be uploaded to the server 103. In one embodiment, the driver's license of the user may be scanned using the scanner 110 and a photograph of the user may be taken using the camera device 111 at the end user terminal 102. The scanned driver's license and the photograph of the user may be stored in the database 104 to verify the identity of the user. A video camera may also be connected to the end user terminal 102 that records transactions in the dispensary.

In one embodiment, a registered user (e.g., cultivators, merchants, customers) of the system 100 can also enter information regarding his bank account via the end user terminal 102. The system administrator reviews the bank account information provided by the user and verifies the bank account of the user based on the information provided by the user. Once the bank account of the user is verified, the system administrator saves the information regarding the user's bank account in the user account saved in the database 104. A registered user of the system 100 can only use the bank account saved in the database 104 under his user account in order to buy and/or sell a controlled substance. Once a user is successfully logged-in, the user may begin the purchase and/or sale of a controlled substance via the home screen of the system 100 displayed on the end user terminal 102 via the POS application 101. It should be understood that the end user terminal may be in a dispensary or elsewhere, for example, the end user terminal may be a personal computer with network access to the system 100.

In one embodiment, a top bar of the home screen of the system 100 includes multiple tabs including an administration tab, compliance reporting tab, help tab (or a “?” icon) or the like. If the help tab or the “?” icon is pressed, a website will open up with help text for the user. The home screen of the system 100 displayed on the end user terminal 102 also includes a log-off button, which can be used by the user to log-off from his user account in the system 100.

In this embodiment, under the administration tab several options (e.g., user set-up, customer profile, merchant profile, inventory master, vendor and cultivator, or the like) can appear in the drop down menu. Using the options from the drop down menu of the administration tab, a system administrator can setup a user profile. Using the drop down menu of the administration tab, a system administrator can also create, edit or delete customer profiles and/or a merchant profile associated with a registered customer user or a merchant user of the system 100, access inventory master to see the list of available inventory at a dispensary of a merchant, and also check the list of vendors and cultivators registered in the system 100 as users.

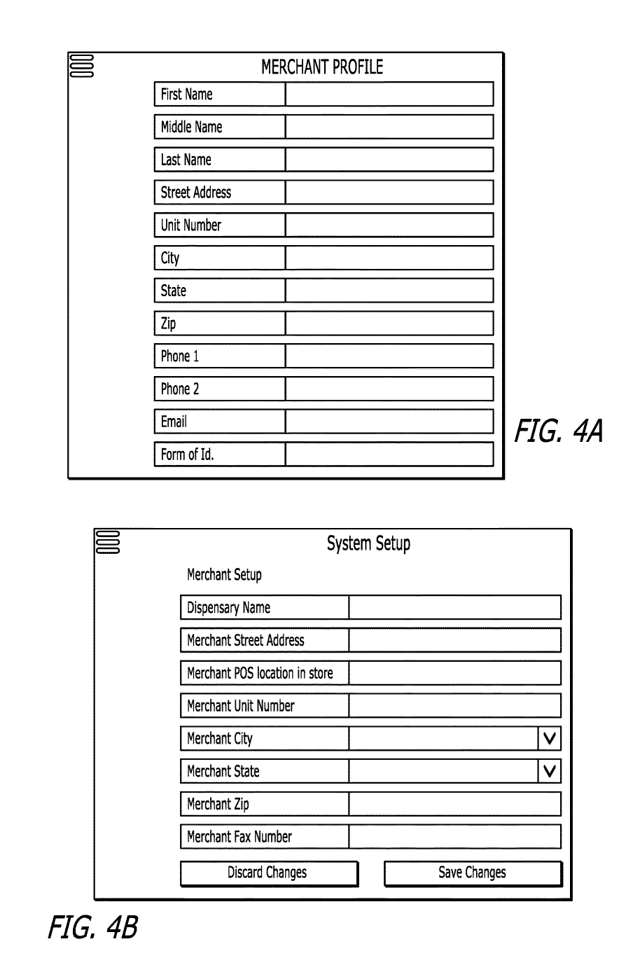

For example, as shown in FIGS. 4A-4B and tables 3 and 4, the system administrator can create a merchant's profile associated with a merchant user of the system by entering the dispensary name, full address of the dispensary, the end user terminal 102 location in the dispensary, and phone and/or fax number of the dispensary of the merchant in the system 100.

### Merchant Profile:

TABLE 3
Merchant profile information saved in database.

| SCREEN FIELD NAME | FIELD LENGTH & TYPE | COMMENTS |
|---|---|---|
| First Name | 20 characters alpha | Mandatory |
| | numeric | |
| Middle Name | 10 characters alpha | Mandatory |
| | numeric. | |
| Last Name | 20 characters alpha | Mandatory |
| | numeric | |
| Street Address | 20 characters alpha | Mandatory |
| | numeric | |
| Unit Number | 10 characters alpha | Mandatory |
| | numeric | |
| City | Drop Down | Mandatory |
| State | Drop Down | Mandatory |
| Zip | 10 digit numeric | Mandatory |
| Phone 1 | 10 characters alpha | Mandatory |
| | numeric | |
| Phone 2 | 10 characters alpha | |
| | numeric | |
| Email | 30 characters alpha | |
| | numeric | |
| Form of Id. | 30 characters alpha | Mandatory |
| | numeric | |
| Expiry Date | Date | Mandatory |

### Dispensary Setup:

TABLE 4
Dispensary setup information saved in database.

| SCREEN FIELD | | |
|---|---|---|
| NAME | FIELD LENGTH & TYPE | COMMENTS |
| Dispensary Name | 30 characters alpha | Mandatory |
| | numeric | |
| Merchant Street | 30 characters alpha | Mandatory |
| Address | numeric. | |
| Merchant POS | 30 characters alpha | |
| Location in Store | numeric. | |
| Merchant Unit | 10 characters alpha | Mandatory |
| Number | numeric | |
| Merchant City | 20 characters alpha | Mandatory |
| | numeric | |
| Merchant State | 2 characters alpha numeric | Mandatory |
| Merchant Zip | 9 characters alpha numeric | Mandatory |
| Merchant | 10 characters alpha | Mandatory |
| Telephone Number | numeric | |
| Merchant Fax | 10 characters alpha | |
| Number | numeric | |

In one embodiment, the merchant can customize the transaction from the end user terminal of the dispensary of the merchant by customizing the POS application 101 settings of the dispensary under merchant's profile associated with the user account of the merchant saved in the database 104 of the server 103. For example, as shown in FIG. 30, the merchant can customize the amount of time per day the POS application 101 of the dispensary can be used offline, the number of offline transactions per day, a specific range of hours per day for offline transactions, and the number of minutes after which the POS application 101 of the dispensary will be locked if unused. The merchant can also save appropriate tax rates for medical drug merchandise and non-medical drug merchandise in the database 104 under the user account of the merchant saved in the database 104. During a transaction, the appropriate tax rate for the drug and non-drug merchandise will be automatically applied to the merchandise for ease of transaction and minimize human error. By customizing the POS application 101 to work offline for a limited number of hours, and conduct offline transactions, ensures the smooth operation of the dispensary in case of a loss of internet connection. The following table 5 shows an example of the POS application 101 setup information stored in the database.

TABLE 5
POS setup saved in database.
POS SET-UP

| | | |
|---|---|---|
| Allow offline POS | Drop down | Y or N |
| use | | |
| Offline Transactions | 4 digit numeric | How many offline |
| | | transactions before POS |
| | | stops in offline mode. |
| Offline Hours | 4 digit numeric | How many hours before |
| | | POS stops in offline mode. |
| Lock POS after | 2 digit numeric | |
| minutes | | |
| Tax Rate 1 for | 4 digit numeric with 2 | |
| Medical Drugs | decimal places | |
| Tax Rate 2 for | 4 digit numeric with 2 | |
| Recreational Drugs | decimal places | |
| Tax Rate 2 for non- | 4 digit numeric with 2 | |
| Drugs | decimal places | |

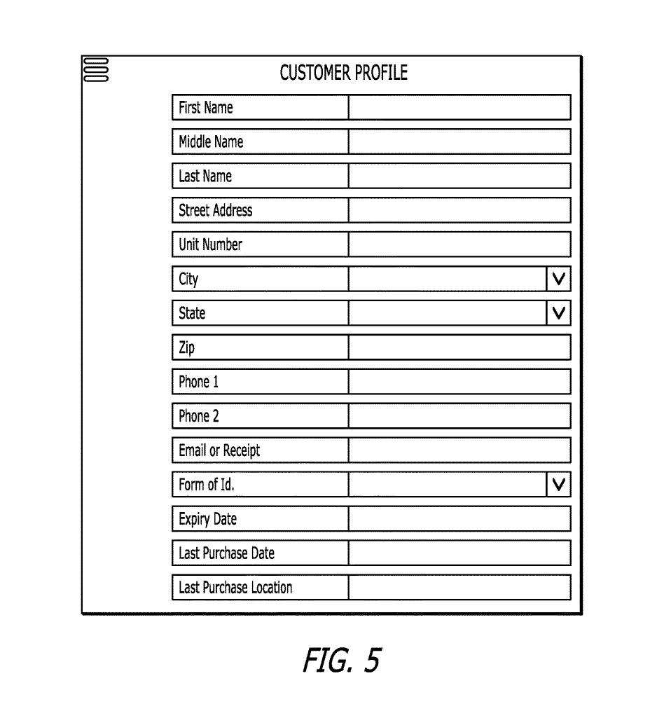

In one embodiment, the system administrator may also create a customer profile associated with a customer user of the system 100 by entering the full name, address, phone number, email address, the driver's license or any other government ID of the customer, and expiry date of the customer's ID, as shown in FIG. 5. The customer profile also includes the date and location of last purchase of controlled substance by the customer. Table 6 discloses an example of the customer profile information saved in the database.

TABLE 6
Customer profile information saved in the database.

| SCREEN FIELD NAME | FIELD LENGTH & TYPE | COMMENTS |
|---|---|---|
| First Name | 20 characters alpha | Mandatory |
| | numeric | |
| Middle Name | 10 characters alpha | Mandatory |
| | numeric. | |
| Last Name | 20 characters alpha | Mandatory |
| | numeric | |
| Street Address | 20 characters alpha | |
| | numeric | |
| Unit Number | 10 characters alpha | |
| | numeric | |
| City | Drop down | |
| State | Drop down | |
| Zip | 10 digit numeric | |
| Phone 1 | 10 characters alpha | |
| | numeric | |
| Phone 2 | 10 characters alpha | |
| | numeric | |
| Email for Receipt | 30 characters alpha | |
| | numeric | |
| Form of Id. | 30 characters alpha | Mandatory |
| | numeric | |
| Expiry Date | Date | Mandatory |
| Last Purchase Date | Date | System Updated |
| Last Purchase | | System Updated |
| Location | | |
| Email or Print | Drop Down - E, H or B | Email, Hard Copy |
| receipt | or Both | |
| Customer Reward | 10 digit alpha numeric | |
| Program Number | | |

In one embodiment, at the beginning of each business day, the system 100 checks the bank account status (e.g., open/close) of at least one or all of the cultivators, merchants, customers of the system 100. If the registered bank account of a user is closed, no transaction by that user will be accepted by the POS application 101. In this embodiment, the system 100 does not process any transaction from a user unless the user has a registered bank account saved in the database 104 under his user account and uses the registered bank account for 100% of transactions. In other embodiments, a customer may use cash or a credit card to purchase a controlled substance. In some embodiments, a customer may slide the debit or credit card in a card reader attached to the end user terminal to complete the purchase of the controlled substance.

In one embodiment, the customer can pay cash in order to buy the controlled substance. In this case, during the transaction of the controlled substance, the clerk or the merchant enters the cash amount received at the POS application 101 in the end user terminal 102. As soon as the merchant enters the amount of cash received at the POS 101, the cash drawer connected to the end user terminal 102 opens and the amount of changes to be given is displayed on the end user terminal 102 screen. The POS application 101 prints or emails a receipt to the customer. The clerk will ask the customer whether he prefers a hard copy receipt or electronic. An email may be stored in the customer profile in the database 104 of the system 100.

In one embodiment, the processor 106 of the system 100 records every purchase and sale made by each of a plurality of cultivators, merchants and customers of the system 100 and saves the records in the database 104. The compliance reporting system 105 accesses the purchase records of the vendors for anti-money laundering reporting to the government and the investors of the system 100. The purchase and sales records helps the compliance reporting system 105 to report any money laundering through cultivators, merchants, or customers to the government and the investors of the system 100. The system 100 also records merchant shipments for reporting when purchase is made. Table 7 discloses an example of the transaction record of a customer saved in the database. Also, table 8 discloses an example of the transaction record of a vendor and a cultivator saved in the database.

TABLE 7
Transaction record of a customer saved in the database

| SCREEN FIELD NAME | FIELD LENGTH & TYPE | COMMENTS |
|---|---|---|
| Drug compliance | Drop Down - Yes or No | |
| needed? | | |
| Date sold | Date | Automatically updated. |
| Time sold | Date | Automatically updated. |
| Item Number | 20 characters alpha | |
| | numeric | |
| RFID Number | 50 characters alpha | Entered or scanned into the system |
| | numeric | |
| Quantity Sold | 9 digit numeric | |
| Dollar Amount | 9 digit numeric with two | |
| | decimal places | |

CUSTOMER INFORMATION

| | | |
|---|---|---|
| Customer First | 20 character alpha | |
| Name | numeric | |
| Customer Middle | 10 character alpha | |
| Name | numeric | |
| Customer Last | 20 character alpha | |
| Name | numeric | |
| Id Type | 4 character alpha numeric | 1 = Driving License. |
| Driving License # | 20 characters alpha | The IDWedgeBT-Portable Form Filler HID |
| | numeric | model scanner will be used for Driving |
| | | Licenses. |
| State | 2 characters alpha numeric | Populated through scanner |
| Expiry Date | Date | Populated through scanner |

PAYMENT

| | |
|---|---|
| Check Number | N.A. in version 1 but create the field in |
| | the table. |
| Bank Name | N.A. in version 1 but create the field in |
| | the table. |

TABLE 8
Transaction record of a vendor and a cultivator saved in
the database

| SCREEN FIELD NAME | FIELD LENGTH & TYPE | COMMENTS |
|---|---|---|
| Type | 1 character alpha numeric | 1 Cultivator |
| Organization Name | 30 characters alpha | 2 Vendor 3 Both |
| | numeric | |
| First Name | 20 characters alpha | Mandatory |
| | numeric | |
| Middle Name | 10 characters alpha | Mandatory |
| | numeric. | |
| Last Name | 20 characters alpha | Mandatory |
| | numeric | |
| Street Address | 20 characters alpha | |
| | numeric | |
| Unit Number | 10 characters alpha | |
| | numeric | |
| City | Drop Down | |
| State | Drop Down | |
| Zip | 10 digit numeric | |
| Phone 1 | 10 characters alpha | |
| | numeric | |
| Phone 2 | 10 characters alpha | |
| | numeric | |
| Email for Receipt | 30 characters alpha | |
| | numeric | |
| Form of Id. | 30 characters alpha | Mandatory |
| | numeric | |
| Expiry Date | Date | Mandatory |
| Last Sold Date | Date | System Updated |
| Last Sold Location | | System Updated |
| Validated by Shield | | Cloud updates |
| | | this |
| Cultivator or | | Cloud updates |
| Wholesale license | | this |
| number | | |

In one embodiment, the server 103 further includes a compliance reporting system 105. The compliance reporting system 105 is in communication with the database 104 and a processor 106 in the server 103, and is configured to ensure that all government regulations are adhered to by the vendors and/or cultivators, merchants and the customers who are using the system 100 to purchase and/or sell a controlled substance. In one embodiment, the dispensaries which fail to adhere to the requirement of the government regulations, are shut down by the appropriate authorities, and the bank account of those dispensaries are deactivated by the investors of the dispensary. The compliance reporting system 105 also may be configured to ensure that there is no money laundering through merchants, cultivators or customers. In the event any government regulations are violated, the compliance reporting system 105 stops a transaction in real time including a purchase and/or sale of a controlled substance.

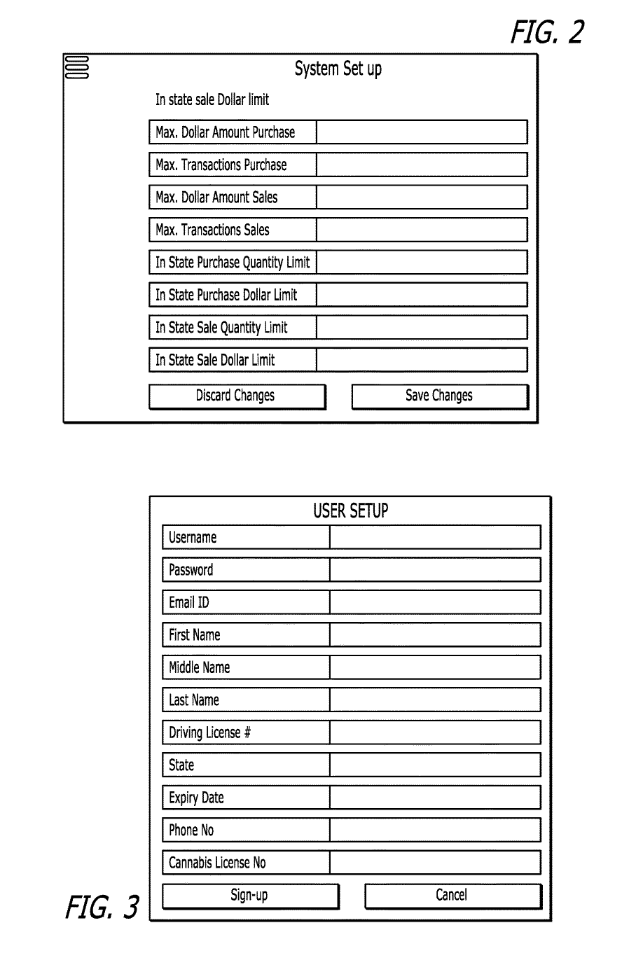

In some embodiments, as shown in FIG. 2, the system administrator can setup the compliance rules for each dispensary associated with each merchant's account in the database 104 of the system 100. The compliance rules are used to verify and ensure that all government regulations are adhered by the dispensaries of the merchants during the purchase and/or sell of a controlled substance. Compliance rules include information regarding maximum dollar amount for purchase per transaction, maximum number of purchases per day, maximum dollar amount for sale per transaction, maximum number of sales per day, quantity limit (e.g., 1 oz.) of controlled substance, and the like. The compliance rules may be specific depending on state laws. The system administrator can also edit, update or delete the compliance rules.

Using the compliance reporting system 105 of the server 103 via the options from the drop down menu of the compliance reporting tab of the home screen, a system administrator can generate reports on a total number of transactions per customer, user identity verification, licensing validation, user bank information, and the like. The reports are stored in the database 104 of the server 103 and are sent to the investors of the system 100 or the governmental authorities in bulk in regular intervals. Table 9 below discloses an example of the compliance rules saved in the database.

TABLE 9
compliance rules saved in the database
COMPLIANCE RULES

| | | |
|---|---|---|
| Maximum Dollar | 7 digit numeric with 2 | Maximum allowed dollar |
| Amount - Purchase | decimal places | amount for purchase |
| | | per day |
| Maximum | 4 digit numeric | Maximum allows purchase |
| Transactions - | | transactions per day |
| Purchase | | |
| Maximum Dollar | 7 digit numeric with 2 | Maximum allowed dollar |
| Amount - Sales | decimal places | amount for sales |
| | | per day |
| Maximum | 4 digit numeric | Maximum allowed sales |
| Transactions - Sale | | transactions per day |
| In State Purchase | 7 digit numeric with 3 | |
| Quantity Limit | decimal places | |
| In State Purchase | 7 digit numeric with 2 | |
| Dollar Limit | decimal places | |
| In State Sale | 4 digit numeric | |
| Quantity Limit | | |
| In State Sale Dollar | 7 digit numeric with 2 | |
| Limit | decimal places | |

In one embodiment, the compliance reporting system 105 is an integral part of the system 100. Compliance reporting system 105 may be used by the bank to ensure that all dispensaries are following the legal requirements. Dispensaries which fail to adhere to the requirements could be shut down by the authorities of the bank. Their bank accounts also may be deactivated. In one embodiment, the database 104 includes database tables which may hold the compliance rules and other user information that may be used by the compliance reporting system. These tables may be populated through the upload of an Excel file or the user may enter the data directly into the table, which can be a one-time upload. The compliance reports are stored in the database 104 of the server 103 and sent to governmental or regulation authorities in batch. The reports may be sent to any user with interest in the reports, including financial institutes and investors.

By way of example only, the compliance reporting system may send reports to the Department of Treasury Financial Crimes Enforcement Network (FinCEN). In one embodiment, the compliance reporting system 105 collects and links all related subject information concerning all users, institutional information, bank branch information, and MRB (Marijuana Related Business) information results in an automated batch filing of suspicious activity reports (SARs) and current transaction reports (CTRs) information to the FinCEN system.

In this embodiment, limited SARs, continuing SARs, priority SARs, termination SARs and CTRs may be continuously or periodically batch filed using the compliance reporting system 105. In the case of continuing SARs, the system collects all relevant MRB transactional information (deposits, withdrawals, and all Automated Clearing House activity) over the last 120 days (or another predefined period) and batch files a continuing SAR for each required MRB. The compliance reporting system 105 also monitors when cash activity exceeds $10,000 (or any other predefined amount) in a 24-hour period (or any predefined period of time), collects the relevant CTR ‘Agent’ and ‘Messenger’ information and files the CTR with FinCEN. The compliance reporting system 105 may provide a tethered computer, such as an tablet, iPad, or any device tethered or not tethered, to each bank teller able to receive MRB deposits. The bank teller may verify that a depositor is an agent of the account if the person making the deposit is registered. If the depositor is a messenger (third party not registered on the account) the bank teller may take a picture of the identity (ID) card provided (driver license, passport, etc.) and ask the messenger to verify the latest information on the ID. The bank teller may enter any updated identity information into the system through the tethered computer. The bank teller also may confirm what information has changed for that messenger if the messenger has had a previous transaction for the MRB account at the bank. If the messenger is an armored car driver, the bank teller may record the First Name, Last Name and personal address of the messenger if the messenger elects to provide his or her address. All of the information associated with the transaction is stored in the data base of the system and pre-populated into the FinCEN Batch file and Secure Data Transferred to the Department of Treasury.

In one embodiment, several options (e.g., administrative option, compliance reporting option, and the like) may appear in the home screen of the system 100 displayed via the POS application 101 on the end user terminal 102. The user may open the POS application 101 browser and choose the option Compliance Reporting, which will also include several hyperlinks for the user to choose from.

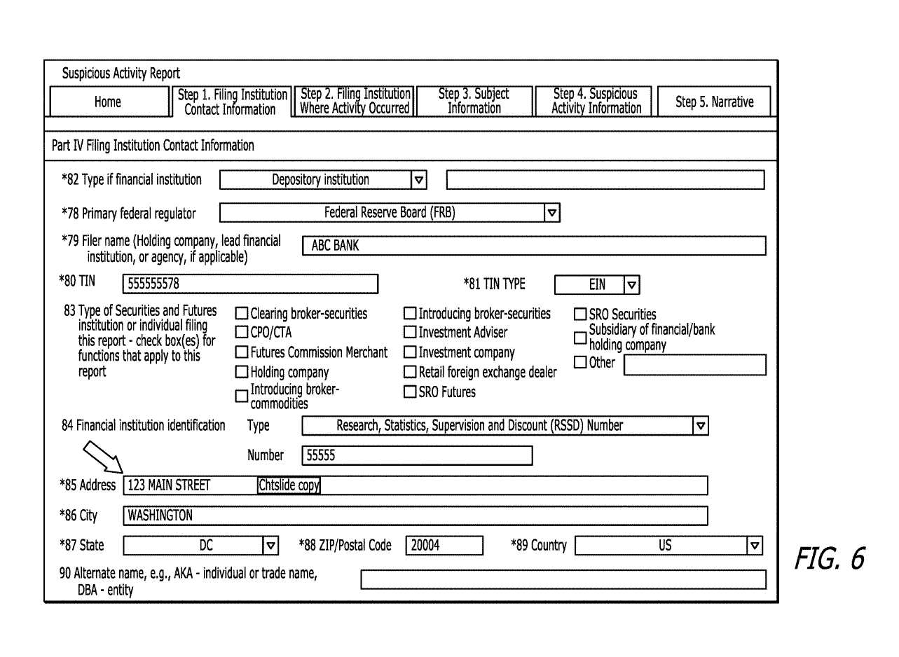

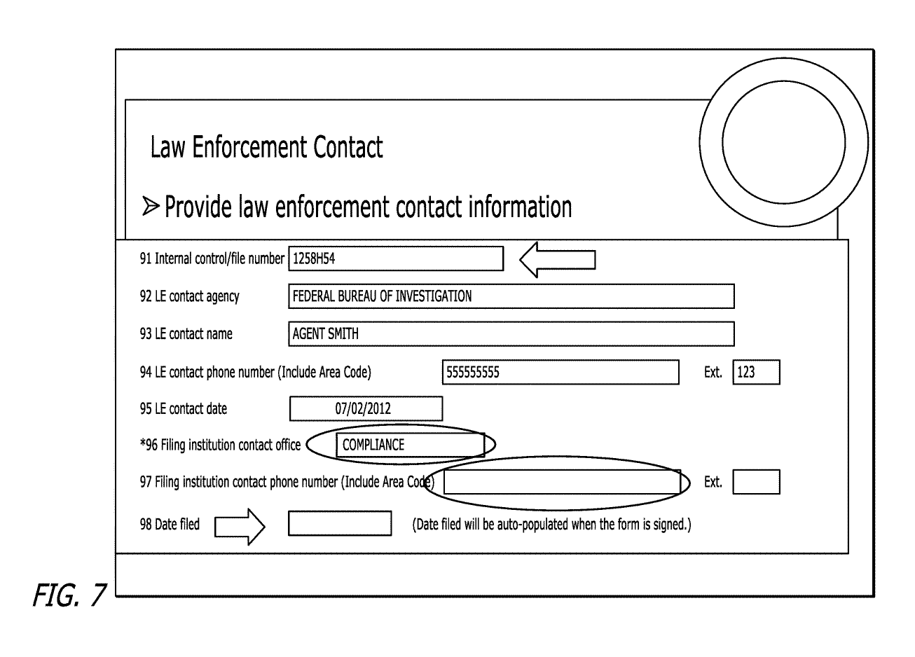

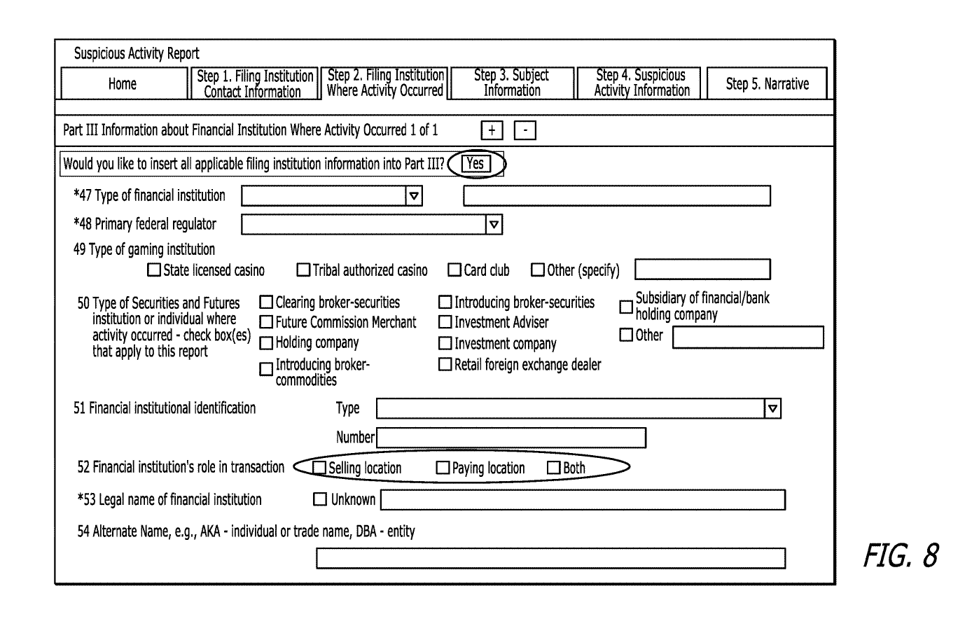

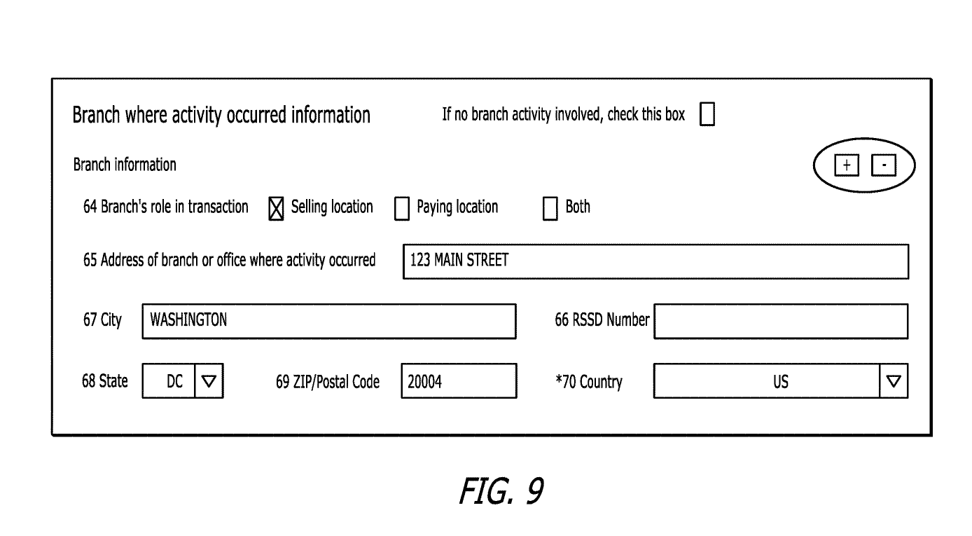

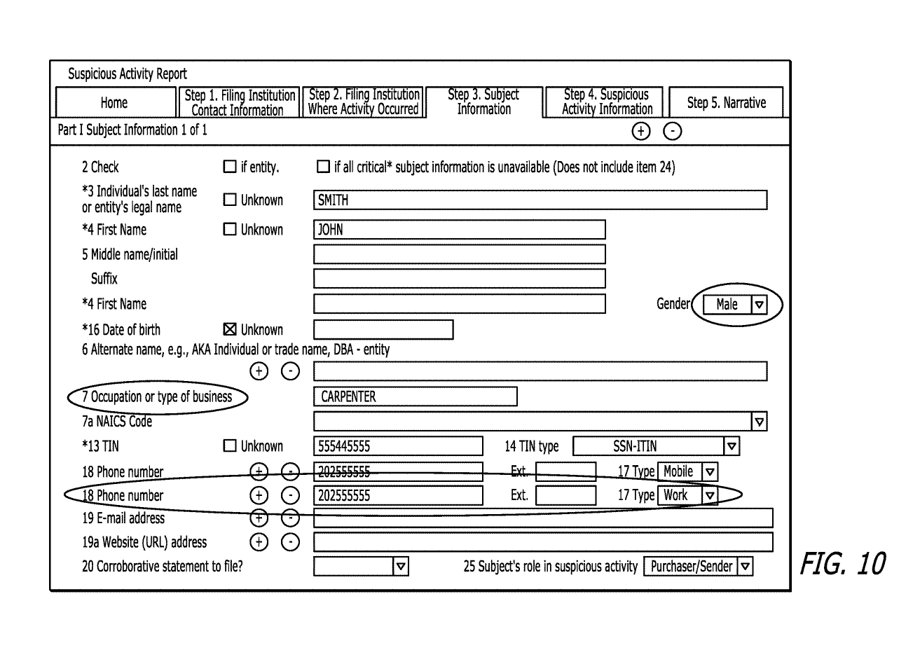

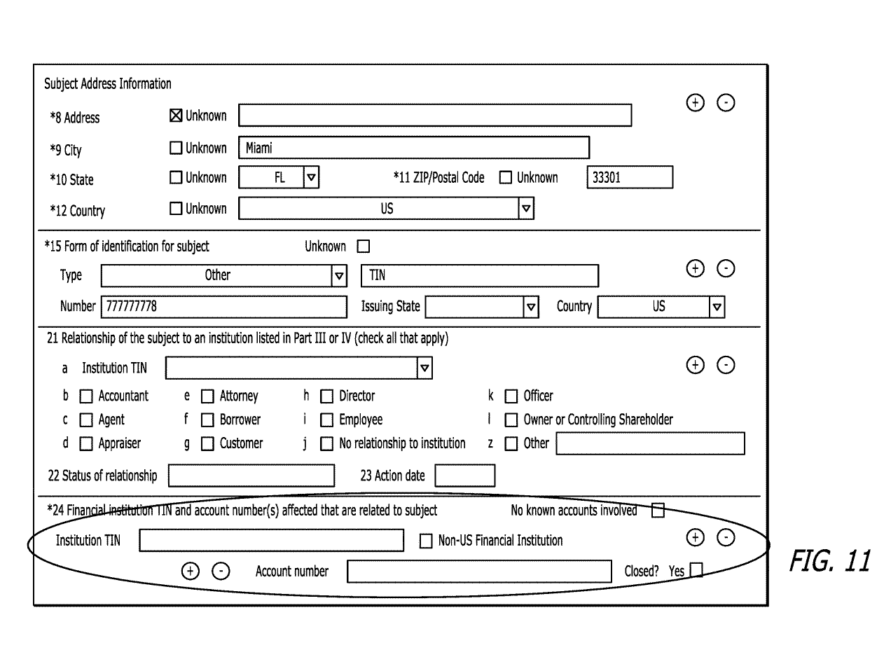

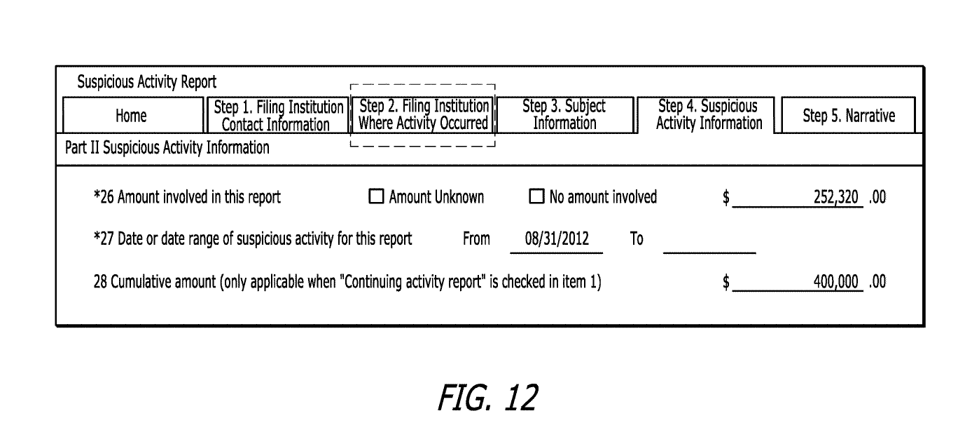

Using the compliance reporting system 105 of the server 103 via the options from the drop down menu of the compliance reporting tab of the home screen, a user may report suspicious activity to the authorities by providing any one of the following: the institute contact information (FIG. 6), law enforcement contact (FIG. 7), information about financial institution where the suspicious activity occurred (FIG. 8), branch activity (page two of report institution where activity occurred) (FIG. 9), suspicious activity report: part I subject information (FIG. 10), suspicious activity report: page 2 of part I subject information (FIG. 11), suspicious activity report: part II suspicious activity information (FIG. 12). The following tables (Table 10-Table 16) illustrate the information regarding different financial activity reports stored in the database.

Institution Contact Information:

TABLE 10
Institution contact information saved in the database

| SCREEN FIELD NAME | FIELD LENGTH & TYPE | COMMENTS |
|---|---|---|
| Type of financial | Drop Down | Depository Institution |
| institution | | |
| Primary federal | Drop Down | Federal Reserve Board (FRB) |
| regulator | | |
| Filer Name (Holding | 60 characters alpha | ABC Bank |
| company, lead | numeric | |
| financial institution, | | |
| or agency, if | | |
| applicable) | | |
| TIN | 10 digit alpha numeric | 555555578 |
| Type of Securities | Check Box | Clearing broker-securities |
| and Futures | | CPO/CTA |
| institution or | | Future Commission Merchant |
| individual filing this | | Holding Company |
| report - check | | Introducing broker-commodities |
| box(es) for functions | | Introducing broker-securities |
| that apply to this | | Investment Adviser |
| report | | Investment company |
| | | Retail foreign exchange dealer |
| | | SRO Futures |
| | | SRO Securities |
| | | Subsidiary of financial/bank holding |
| | | company |
| | | Other |
| Other | 10 character alpha- | If Other is selected from previous field. |
| | numeric | |
| Financial institution | Drop Down | Research, Statistics, Supervisor and |
| identification Type | | Discount 9RSSD) number |
| Number | 10 digit numeric | 55555 |
| Address | 60 characters alpha | 123 Main Street |
| | numeric | |
| City | 30 character alpha | Washington |
| | numeric | |
| State | Drop Down | DC |
| Zip/Postal Code | 10 digit alpha numeric | 20004 |
| Country | Drop Down | US |
| Alternate name, e.g. | 60 character alpha | |
| AKA - individual or | numeric | |
| trade name | | |
| Bank Name | | N.A. in version 1 but create the field in |
| | | the table. |

### Law Enforcement Contact (Second Page of Institution Contact Information)

TABLE 11
law enforcement contact information saved in the database

| | FIELD LENGTH & | |
|---|---|---|
| SCREEN FIELD NAME | TYPE | COMMENTS |
| 91 Internal | 10 digit alpha | 1258H54 |
| control/file number | numeric | |
| 92 LE contact | 60 character | FEDERAL BUREA |
| agency | alpha-numeric | OF INVESTIGATION |
| 93 LE contact name | 30 character | AGENT SMITH |
| | alpha-numeric | |
| 94 LE contact phone | 20 character alpha | 5555555555 |
| number (Include | numeric | |
| Area Code) | | |
| Ext | 4 character alpha | 123 |
| | numeric | |
| 95 LE contact date | Date | Jul. 2, 2012 |
| *96 Filing institution | 20 character alpha | COMPLIANCE |
| contact phone | numeric | |
| number (Include | | |
| Area Code) | | |
| 97 Filing institution | 20 character alpha | |
| contact phone | numeric | |
| number (Include | | |
| Area Code) | | |
| Ext | 4 character alpha | |
| | numeric | |
| Date filed | Date | |

### Information About Financial Institution Where Activity Occurred

TABLE 12
Information about financial institution where activity occurred

| | FIELD LENGTH & | |
|---|---|---|
| SCREEN FIELD NAME | TYPE | COMMENTS |
| *47 Type of financial | Drop Down | |
| institution | | |
| *48 Primary federal | Drop Down | |
| regulator | | |
| 49 Type of gaming | Check box | Stave licensed casino |
| institution | | Tribal authorized casino |
| | | Card club |
| | | Other (specify) |
| Other | 30 character | |
| | alpha-numeric | |
| 50 TYPE OF | Check Box | Clearing broker-securities |
| Securities And | | Futures Commission Merchant |
| Futures institution | | Holding company |
| of individual where | | Introducing broker-commodities |
| activity occurred - | | Introducing broker-securities |
| check box(es) that | | Investment Adviser |
| apply to this report | | Investment company |
| | | Retail foreign exchange dealer |
| | | Subsidiary of financial/bank holding company |
| | | Other |
| 51 Financial | Drop down | |
| institution | | |
| identification Type | | |
| Number | 20 character alpha | |
| | numeric | |
| 52 Financial | Check Box | Selling location |
| institution's role in | | Paying location |
| transaction | | Both |
| *53 Legal name of | 60 character alpha | |
| financial institution | numeric | |
| Unknown | Check Box | |
| Alternate Name, | 60 character alpha | |
| e.g., AKA - | numeric | |
| individual or trade | | |
| name, DBA - entity | | |

### Branch Activity, Page Two of Report Institution Where Activity Occurred

TABLE 13
Information about branch activity, page two of report
institution where activity occurred

| | FIELD LENGTH & | |
|---|---|---|
| SCREEN FIELD NAME | TYPE | COMMENTS |
| 64 Branch's role in | Check Box | Selling location |
| transaction | | Paying location |
| | | Both |
| 65 Address of | 60 character | 123 MAIN STREET |
| branch or office | alpha-numeric | |
| where activity | | |
| occurred | | |
| 66 RSSD Number | 20 digit alpha | 55523 |
| | numeric | |
| 67 City | 30 character alpha | Washington |
| | numeric | |
| 68 State | Drop Down | DC |
| 69 ZIP/Postal Code | 10 digit alpha- | 20004 |
| | numeric | |
| *70 Country | Drop down | US |

### Suspicious Activity Report: Part 1 Subject Information

TABLE 14
Suspicious activity report: part 1 subject information

| SCREEN FIELD | FIELD LENGTH | |
|---|---|---|
| NAME | & TYPE | COMMENTS |
| 2 Check | Check Box | If entity, if all critical* |
| | | subject information is |
| | | unavailable (Does not |
| | | include item 24) |
| *3 Individual's last | 30 characters alpha- | SMITH |
| name or entity's | numeric | |
| legal name | | |
| Unknown | Check Box | |
| 5 Middle | 30 characters alpha | |
| name/initial | numeric | |
| Suffix | 30 characters alpha | |
| | numeric | |
| Gender | Drop Down | Male |
| *Date of birth | Date | |
| Unknown | Check box | |
| 6 Alternate name, | | |
| e.g., AKA - | | |
| individual or trade | | |
| name, DBA - entity | | |
| 7 Occupation or | 30 characters alpha- | CARPENTER |
| type of business | numeric | |
| 7a NAICS Code | Drop Down | |
| *13 TIN | 20 characters alpha | |
| | numeric | |
| Unknown | Check Box | |
| 14 TIN type | Drop Down | SSN-ITIN |
| 18 Phone number | 20 character alpha- | 2025555555 |
| | numeric | |
| Ext. | 10 character alpha- | |
| | numeric | |
| Type | Drop down | Mobile |
| 18 Phone number | 20 character alpha- | 2025552222 |
| | numeric | |
| Ext. | 10 character alpha- | |
| | numeric | |
| Type | Drop down | Mobile |
| 19 E-mail address | 30 character alpha- | |
| | numeric | |
| 19a Website (URL) | 60 character alpha- | |
| address | numeric | |
| 20 Corroborative | Drop Down | |
| statement to filer | | |
| 25 Subject's role in | Drop Drown | Purchase/Sender |
| suspicious activity | | |

### Suspicious Activity Report: Subject Information Page 2 of Part 1

TABLE 15
Suspicious activity report: subject information page 2 of part 1

| SCREEN FIELD | FIELD LENGTH & | |
|---|---|---|
| NAME | TYPE | COMMENTS |
| *Address | 30 character alpha- | |
| | numeric | |
| Unknown | Check-box | |
| *9 City | 39 character alpha- | |
| | numeric | |
| Unknown | Check-box | |
| *10 State | Drop Down | FL |
| Unknown | Check-box | |
| *11 ZIP/Postal Code | 10 digit alpha-numeric | |
| Unknown | Check-box | |
| *12 Country | Drop Down | US |
| Unknown | Check-box | |
| *15 Form of | Check Box | |
| Identification for | | |
| subject | | |
| Type | Drop Down | Other |
| TIN | 30 character alpha- | |
| | numeric | |
| Number | 20 character alpha- | 777777778 |
| | numeric | |
| Issuing State | Drop Down | |
| Country | Drop Down | US |
| Type | Drop down | Mobile |
| 18 Phone number | 20 character alpha- | 2025552222 |
| | numeric | |
| Ext. | 10 character alpha- | |
| | numeric | |
| Type | Drop down | Mobile |
| 19 E-mail address | 30 character alpha- | |
| | numeric | |
| 19a Website (URL) | 60 character alpha- | |
| address | numeric | |
| 20 Corroborative | Drop Down | |
| statement to filer | | |
| 25 Subject's role in | Drop Drown | Purchase/Sender |
| suspicious activity | | |

Relationship of the subject to an institution listed in Part III or IV
(check all that apply)

| | | |
|---|---|---|
| a Institution TIN | Drop Down | |
| | Check Box | b Accountant |
| | | c Agent |
| | | d Appraiser |
| | | e Attorney |
| | | f Borrower |
| | | g Customer |
| | | h Director |
| | | I Employee |
| | | J No relationship to |
| | | institution |
| | | K Officer |
| | | L Owner of Controlling |
| | | Shareholder |
| | | Z Other |
| 22 Status of | 30 character alpha | |
| relationship | numeric | |
| 23 Action Date | Date | |
| *24 Financial | Check Box | |
| institution TIN and | | |
| account number(s) | | |
| affected that are | | |
| related to subject. | | |
| No known accounts | | |
| involved | | |
| Institution TIN | 20 character alpha- | |
| | numeric | |
| Non-Us Financial | Check Box | |
| Institution | | |
| Account number | 20 characters alpha- | |
| | numeric | |
| Closed? Yes | Check Box | |

### Suspicious Activity Report: Part II Suspicious Activity Information

TABLE 16
Suspicious activity report: part ii suspicious activity information

| SCREEN FIELD | FIELD LENGTH & | |
|---|---|---|
| NAME | TYPE | COMMENTS |
| *26 Amount | 10 digit | 252,320 |
| invoiced in this | | |
| report | | |
| Amount Unknown | Check Box | |
| No amount involved | Check box | |
| *27 Date or date | Date | Aug. 31, 2012 |
| range of suspicious | | |
| activity for this | | |
| report From | | |
| To | Date | |
| 28 Cumulative | 10 digit | 400,000 |
| amount (only | | |
| applicable when | | |
| ″Continuing activity | | |
| report″ is checked in | | |
| Item 1) | | |

The user can also file currency transaction reports with the Department of Treasury Financial Crimes Enforcement Network, for example only, which may include information concerning a person involved in a transaction, amount and type of the transaction, and financial institute where the transaction took place using the compliance reporting system 105. By way of example only, Table 17-Table 20 illustrate information regarding the type of filing, person involved in transaction, amount and type of transaction, and financial institute where the transaction took place of the currency transaction report information saved in the database.

### Type of Filing

TABLE 17
information regarding type of filing saved in the database.

| SCREEN FIELD | FIELD LENGTH & | |
|---|---|---|
| NAME | TYPE | COMMENTS |
| Filing Name | 60 characters alpha | |
| | numeric | |
| Type of Filing | Check Box | Initial report, Correct/amend |
| | | prior report, FinCEN directed |
| | | Backfiling |
| Prior report | 60 characters alpha | |
| Document Control | numeric | |
| Number/BSA | | |
| Identifier | | |

### Part I Person Involved in Transaction

TABLE 18
Part I person involved in transaction information stored in the database.

| SCREEN FIELD | FIELD LENGTH & | |
|---|---|---|
| NAME | TYPE | COMMENTS |
| Transaction | Check Box | Person conducting |
| conducted by | | transaction on own |
| | | behalf, Person conducting |
| | | transaction for another, |
| | | Person on whose behalf |
| | | transaction was conducted, |
| | | Courier Service (private), |
| | | Multiple Transactions |
| Individual's last | 60 characters alpha | |
| name or entity's | numeric | |
| legal name | | |
| Unknown | Check Box | Unknown |
| First Name | 60 characters alpha | |
| | numeric | |
| Unknown | Check Box | Unknown |
| Middle Name | 60 characters alpha | |
| | numeric | |
| Suffix | 60 characters alpha | |
| | numeric | |
| Gender | 10 characters alpha | |
| | numeric | |
| Alternate Name | 60 characters alpha | |
| | numeric | |
| Occupation or type | 60 characters alpha | |
| of business | numeric | |
| NAICS Code | 60 characters alpha | |
| | numeric | |
| Address | 60 characters alpha | |
| | numeric | |
| Unknown | Check Box | Unknown |
| City | 60 characters alpha | |
| | numeric | |
| Unknown | Check Box | Unknown |
| State | 30 characters alpha | |
| | numeric | |
| Unknown | Check Box | Unknown |
| Zip/Postal Code | 30 characters alpha | |
| | numeric | |
| Unknown | Check Box | Unknown |
| Country | 30 characters alpha | |
| | numeric | |
| Unknown | Check Box | Unknown |
| TIN | 30 characters alpha | |
| | numeric | |
| Unknown | Check Box | Unknown |
| Tin Type | 10 characters alpha | |
| | numeric | |
| Date of Birth | 10 digits numeric | |
| Unknown | Check Box | Unknown |
| Contact Phone | 20 digit numeric | |
| Number | | |
| Ext. | 10 digit numeric | |
| Email Address | 30 character alpha | |
| | numeric | |
| Form of | Check box | Driver's license/stage Id, |
| identification used | | Passport, Alien |
| to verify identity | | Registration, Other |
| Unknown | Check box | Unknown |
| Number | 20 character alpha | |
| | numeric | |
| Country | 30 characters alpha | |
| | numeric | |
| Issuing State | 30 characters alpha | |
| | numeric | |
| Cash in amount for | 10 digit numeric | |
| individual or entity | | |
| listed in Item 4 | | |
| Account Number | 20 character alpha | |
| | numeric | |
| Cash out amount for | 10 digit numeric | |
| individual listed in | | |
| Item 4 | | |
| Account Number | 20 character alpha | |
| | numeric | |

### Part II Amount and Type of Transactions

TABLE 19
Part II amount and type of transactions information stored
in the database

| SCREEN FIELD | FIELD LENGTH & | |
|---|---|---|
| NAME | TYPE | COMMENTS |
| Date of Transaction | Date | |
| Mode of Transport | Check Box | Armored car (FI Contract), |
| | | ATM, Mail Deposit or |
| | | Shipment, Night Deposit, |
| | | Aggregated transactions |

CASH IN (in U.S. dollar equivalent)

| | |
|---|---|
| Deposit(s) | 10 digit |
| Payment(s) | 10 digit |
| Currency received | 10 digit |
| for funds transfer(s) | |
| out | |
| Purchase of | 10 digit |
| negotiable | |
| instrument(s) | |
| Currency | 10 digit |
| exchange(s) | |
| Currency to prepaid | 10 digit |
| access | |
| Purchases of casinos | 10 digit |
| chips, tokens and | |
| other gaming | |
| instruments | |
| Currency wager(s) | 10 digit |
| including money | |
| plays | |
| Bills inserted into | 10 digit |
| gaming devices | |
| Other (specify) | 10 digit |
| Total Cash In | |

CASH OUT (in U.S. dollar equivalent)

| | |
|---|---|
| Withdrawal(s) | 10 digit |
| Advance(s) on credit | 10 digit |
| (including materials) | |
| Currency paid from | 10 digit |
| funds transfer(s) in | |
| Negotiable | 10 digit |
| instrument(s) | |
| cashed | |
| Currency exchanges | 10 digit |
| Currency from | 10 digit |
| prepaid access | |
| Redemption(s) of | 10 digit |
| casinos chips, | |
| tokens, TITO tickets | |
| and other gaming | |
| instruments | |
| Payment(s) on | 10 digit |
| wager(s) (including | |
| race and OTB or | |
| sports pool) | |
| Travel and | 10 digit |
| complimentary | |
| expenses and book | |
| gaming incentives | |
| Payment for | 10 digit |
| tournament, contest | |
| or other promotions | |
| Other (specify) | 10 digit |
| Total Cash Out | 10 digit |
| Foreign Cash In | 10 digit |
| Foreign Country | 30 characters alpha |
| | numeric |
| Foreign Cash Out | 10 digit |
| Foreign Country | 30 characters alpha |
| | numeric |

### Part III Financial Institution Where Transaction(S) Take Place

TABLE 20
Part III financial institution where transaction(s) take place

| SCREEN FIELD | FIELD LENGTH & | |
|---|---|---|
| NAME | TYPE | COMMENTS |
| Type of financial | 60 characters alpha | |
| institution | numeric | |
| Other (specify) | 60 characters alpha | |
| | numeric | |
| Primary federal | 60 characters alpha | |
| regulator | numeric | |
| If Casino/Card Club | Check Box | State licensed casino, |
| | | tribal authorized casino, |
| | | card club, other |
| Legal Name of | 60 characters alpha | |
| Financial Institution | numeric | |
| Alternate Name e.g. | 60 characters alpha | |
| trade name, DBA | numeric | |
| EIN | 30 characters alpha | |
| | numeric | |
| Address | 60 characters alpha | |
| | numeric | |
| City | 60 characters alpha | |
| | numeric | |
| State | 20 characters alpha | |
| | numeric | |
| ZIP Code | 20 characters alpha | |
| | numeric | |
| Financial institution | 60 characters alpha | |
| Id type | numeric | |
| ID number | 20 characters alpha | |
| | numeric | |
| Contact office | 60 characters alpha | |
| | numeric | |
| Phone number | 20 character numeric | |
| Extension | 10 character alpha | |
| | numeric | |
| Date Filed | Date | |

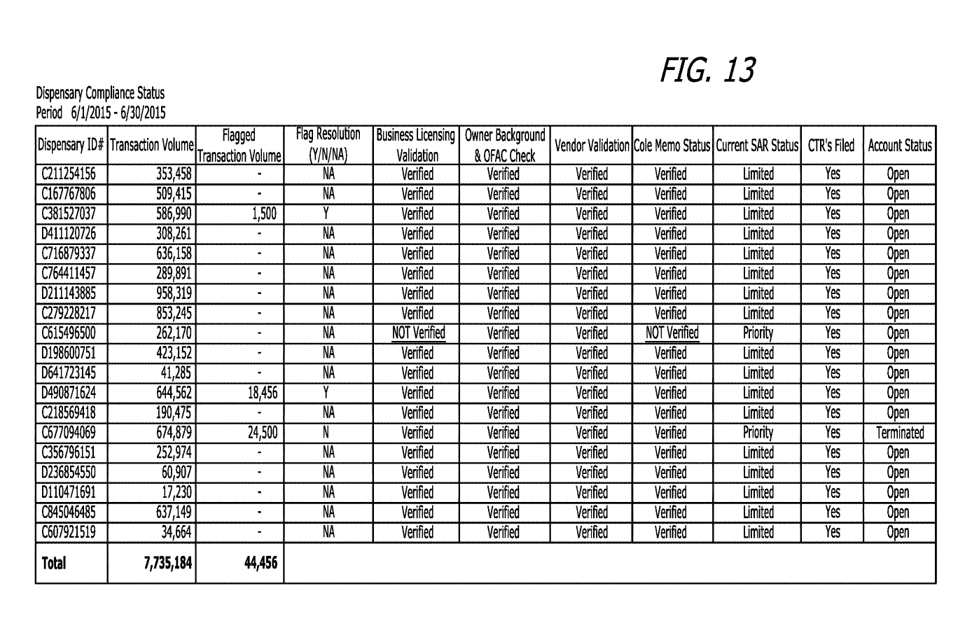

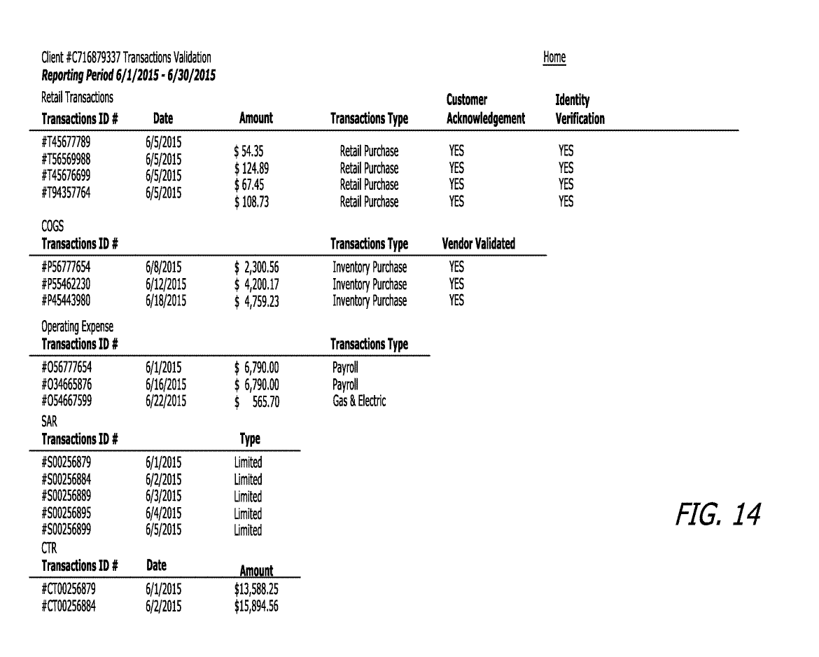

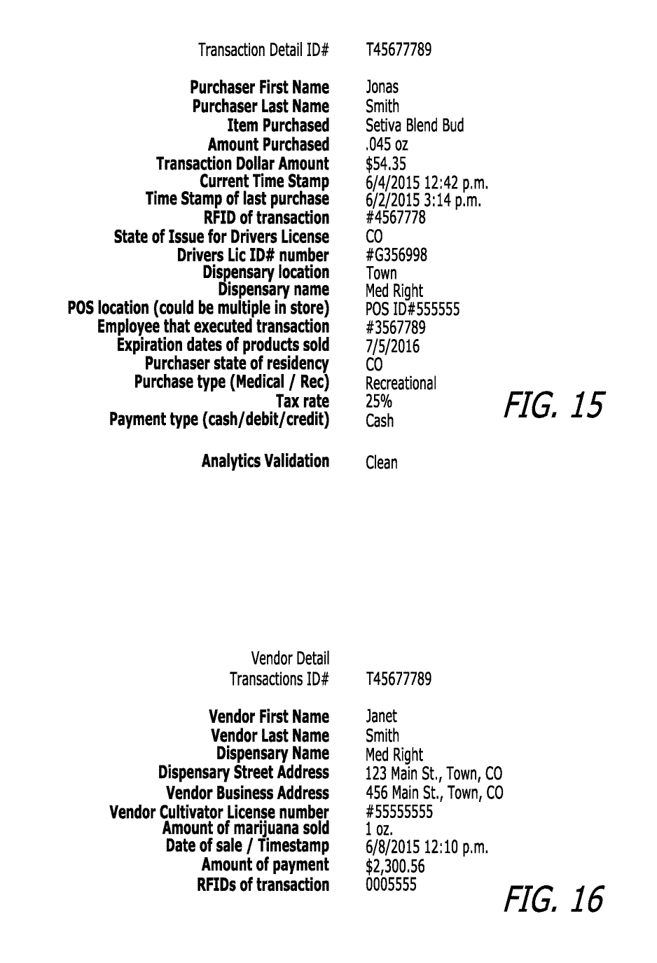

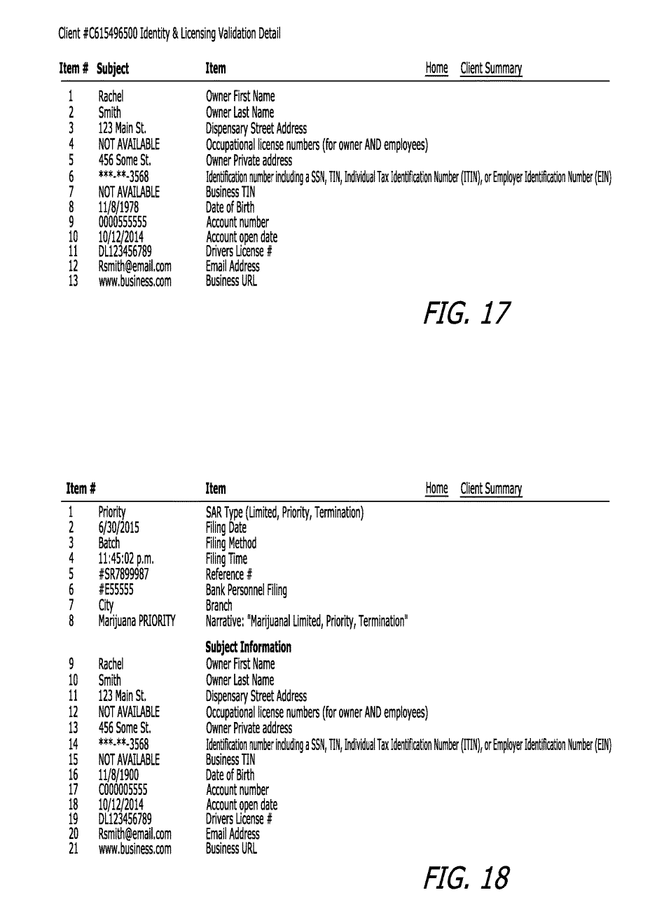

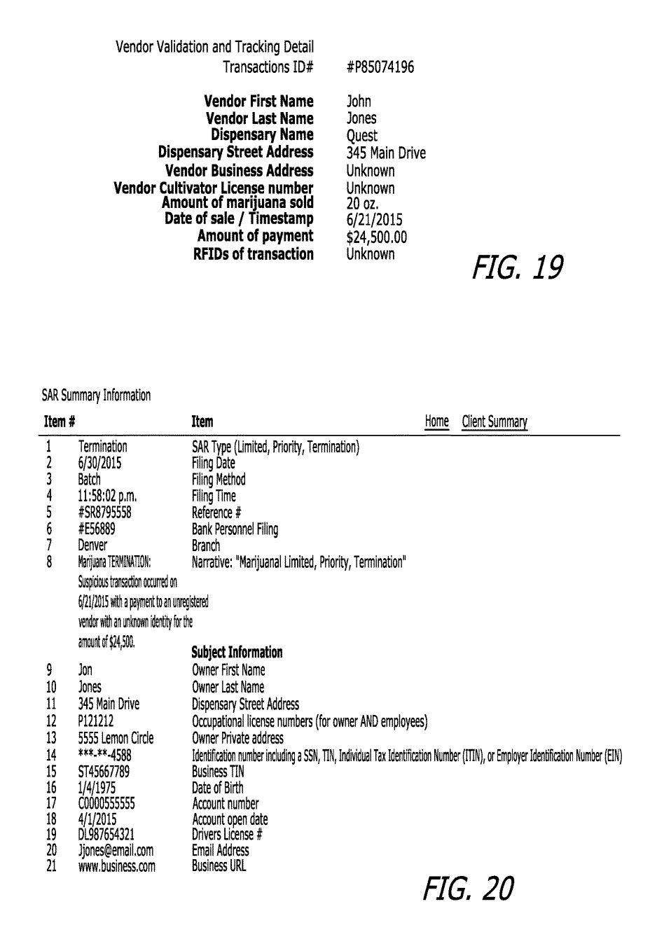

Further, the user can maintain a regulator page (e.g., blank client dashboard (FIG. 13), client transaction validation (FIG. 14), client summary-transaction (FIG. 15), client summary-vendor (FIG. 16), client identity and licensing validation detail (FIG. 17), client summary (FIG. 18), vendor validation and tracking detail (FIG. 19), SAR summary information (FIG. 20) using the compliance reporting system 105). By way of example only, Table 21-Table 28 illustrate information regarding a blank client dashboard, client transaction validation, client summary-transaction, client summary-vendor, client identity and licensing validation, vendor validation and tracking detail, and SAR summary information, that may be saved in the database.

### Regulator Page

### Bank Client Dashboard

TABLE 21
Bank client dashboard information

| SCREEN FIELD | FIELD LENGTH & | |
|---|---|---|
| NAME | TYPE | COMMENTS |
| Dispensary Id | 20 characters alpha | |
| | numeric | |
| Transaction Volume | 10 digits | |
| Flagged Transaction | 10 digits | |
| Volume | | |
| Flag Resolution | 3 digit alpha numeric | |
| (Y/N/NA) | | |
| Business Licensing | 20 characters alpha | |
| Validation | numeric | |
| Owner Background | 20 characters alpha | |
| & OFAC Check | numeric | |
| Vendor Validation | 20 characters alpha | |
| | numeric | |
| Cole Memo Status | 20 characters alpha | |
| | numeric | |
| Current SAR Status | 20 characters alpha | |
| | numeric | |
| CTR's Filed | 3 characters alpha numeric | |
| Account Status | 4 characters alpha numeric | |

### Client Transaction Validation (C716879337)

TABLE 22
Client transaction validation information

| SCREEN FIELD | FIELD LENGTH & | |
|---|---|---|
| NAME | TYPE | COMMENTS |
| Type of Transaction | 20 character alpha | |
| | numeric | |
| Transaction ID # | 20 character alpha | |
| | numeric | |
| Date | Date | |
| Amount | 10 digit | |
| Transaction type | 20 character alpha | |
| | numeric | |
| Customer | 3 character alpha numeric | |
| Acknowledgement | | |
| Identify Verification | 3 character alpha numeric | |

### Client Summary—Transactions (T45677789)

TABLE 23
Client summary: transactions information

| SCREEN FIELD | FIELD LENGTH & | |
|---|---|---|
| NAME | TYPE | COMMENTS |
| Purchaser First | 30 character alpha | |
| Name | numeric | |
| Purchaser Last | 30 character alpha | |
| Name | numeric | |
| Item Purchased | 30 character alpha | |
| | numeric | |
| AmountPurchased | 6 digit with 3 decimal | |
| | places. | |
| Transaction Dollar | 6 digit with 2 decimal | |
| Amount | places | |
| Current Time Stamp | Date & Time | |
| Time Stamp of last | Date & Time | |
| purchase | | |
| RFID of transaction | 20 character alpha | |
| | numeric | |
| State of Issue for | 2 characters alpha numeric | |
| Drivers License | | |
| Drivers Lic ID# | 10 character alpha | |
| number | numeric | |
| Dispensary location | 20 character alpha | |
| | numeric | |
| Dispensary name | 30 character alpha | |
| | numeric | |
| POS location (could | 20 character alpha | |
| be multiple in store) | numeric | |
| Employee that | 20 character alpha | |
| executed | numeric | |
| transaction | | |
| Expiration dates of | Date | |
| products sold | | |
| Purchaser state of | 2 character alpha numeric | |
| residency | | |
| Purchase Type | 10 character alpha | |
| (Medical/Rec) | numeric | |
| Tax rate | 3 digit | |
| Payment type | 5 character alpha numeric | |
| (cash/debit/credit) | | |
| Analytics Validation | 10 character alpha | |
| | numeric | |

### Client Summary—Vendor (P56777654)

TABLE 24
Client summary: Vendor information

| SCREEN FIELD | FIELD LENGTH & | |
|---|---|---|
| NAME | TYPE | COMMENTS |
| Vendor First Name | 30 character alpha | |
| | numeric | |
| Vendor Last Name | 30 character alpha | |
| | numeric | |
| Dispensary Name | 30 character alpha | |
| | numeric | |
| Dispensary Street | 60 character alpha | |
| Address | numeric | |
| Vendor Business | 60 characters alpha | |
| Address | numeric | |
| Vendor Cultivator | 10 character alpha | |
| License Number | numeric | |
| Amount of | 20 character alpha | |
| Marijuana Sold | numeric | |
| Date of sale/ | 30 character alpha | |
| timestamp | numeric | |
| Amount of payment | 20 character alpha | |
| | numeric | |
| RFID of Transaction | 10 character alpha | |
| | numeric | |

### Client Identity & Licensing Validation Detail

TABLE 25
Client identity & licensing validation detail

| SCREEN FIELD | FIELD LENGTH & | |
|---|---|---|
| NAME | TYPE | COMMENTS |
| Owner First Name | 30 character alpha | |
| | numeric | |
| Owner Last Name | 30 character alpha | |
| | numeric | |
| Dispensary Street | 60 character alpha | |
| Address | numeric | |
| Occupational license | 20 character alpha | |
| numbers (for owner | numeric | |
| AND employees) | | |
| Owner Private | 60 character alpha | |
| address | numeric | |
| Identification | 10 character alpha | |
| number including a | numeric | |
| SSN, TIN, Individual | | |
| Tax Identification | | |
| Number (ITIN), or | | |
| Employer | | |
| Identification | | |
| Number (EIN). | | |
| Business TIN | 10 character alpha | |
| | numeric | |
| Date of Birth | Date | |
| Account Number | 20 character alpha | |
| | numeric | |
| Account open date | Date | |
| Driver's License # | 10 character alpha | |
| | numeric | |
| Email Address | 30 character alpha | |
| | numeric | |
| Business URL | 60 character alpha | |
| | numeric | |

### Client Summary (S83974731)

TABLE 26
Client Summary

| SCREEN FIELD | FIELD LENGTH & | |
|---|---|---|
| NAME | TYPE | COMMENTS |
| SAR Type (Limited, | 10 character alpha | |
| Priority, | numeric | |
| Termination) | | |
| Filing Date | Date | |
| Filing Method | 10 character alpha | |
| | numeric | |
| Filing Time | Time | |
| Reference # | 10 character alpha | |
| | numeric | |
| Bank Personnel | 10 character alpha | |
| Filing | numeric | |
| Branch | 10 character alpha | |
| | numeric | |
| Narrative | 20 character alpha | Marijuana Limited, |
| | numeric | Priority, Termination |

SUBJECT INFORMATION

| | |
|---|---|
| Owner First Name | 30 character alpha |
| | numeric |
| Owner Last Name | 30 character alpha |
| | numeric |
| Dispensary Street | 60 character alpha |
| Address | numeric |
| Occupational license | 20 character alpha |
| numbers (for owner | numeric |
| AND employees) | |
| Owner Private | 60 character alpha |
| address | numeric |
| Identification | 10 character alpha |
| number including a | numeric |
| SSN, TIN, Individual | |
| Tax Identification | |
| Number (ITIN), or | |
| Employer | |
| Identification | |
| Number (EIN). | |
| Business TIN | 10 character alpha |
| | numeric |
| Date of Birth | Date |
| Account Number | 20 character alpha |
| | numeric |
| Account open date | Date |
| Driver's License # | 10 character alpha |
| | numeric |
| Email Address | 30 character alpha |
| | numeric |
| Business URL | 60 character alpha |
| | numeric |

### Vendor Validation and Tracking Detail (P85074196)

TABLE 27
Vendor validation and tracking detail

| SCREEN FIELD | FIELD LENGTH & | |
|---|---|---|
| NAME | TYPE | COMMENTS |
| Vendor First Name | 30 character alpha | |
| | numeric | |
| Vendor Last Name | 30 character alpha | |
| | numeric | |
| Dispensary Name | 30 character alpha | |
| | numeric | |
| Dispensary Street | 60 character alpha | |
| Address | numeric | |
| Vendor Business | 60 characters alpha | |
| Address | numeric | |
| Vendor Cultivator | 10 character alpha | |
| License Number | numeric | |
| Amount of | 20 character alpha | |
| Marijuana Sold | numeric | |
| Date of sale/ | 30 character alpha | |
| timestamp | numeric | |
| Amount of payment | 20 character alpha | |
| | numeric | |
| RFID of Transaction | 10 character alpha | |
| | numeric | |

TABLE 28
SAR summary information

| SCREEN FIELD | FIELD LENGTH & | |
|---|---|---|
| NAME | TYPE | COMMENTS |
| SAR Type (Limited, | 10 character alpha | |
| Priority, | numeric | |
| Termination) | | |
| Filing Date | Date | |
| Filing Method | 10 character alpha | |
| | numeric | |
| Filing Time | Time | |
| Reference # | 10 character alpha | |
| | numeric | |
| Bank Personnel | 10 character alpha | |
| Filing | numeric | |
| Branch | 10 character alpha | |
| | numeric | |
| Narrative | 20 character alpha | Marijuana Limited, |
| | numeric | Priority, Termination |

SUBJECT INFORMATION

| | |
|---|---|
| Owner First Name | 30 character alpha |
| | numeric |
| Owner Last Name | 30 character alpha |
| | numeric |
| Dispensary Street | 60 character alpha |
| Address | numeric |
| Occupational license | 20 character alpha |
| numbers (for owner | numeric |
| AND employees) | |
| Owner Private | 60 character alpha |
| address | numeric |
| Identification | 10 character alpha |
| number including a | numeric |
| SSN, TIN, Individual | |
| Tax Identification | |
| Number (ITIN), or | |
| Employer | |
| Identification | |
| Number (EIN). | |
| Business TIN | 10 character alpha |
| | numeric |
| Date of Birth | Date |
| Account Number | 20 character alpha |
| | numeric |
| Account open date | Date |
| Driver's License # | 10 character alpha |
| | numeric |
| Email Address | 30 character alpha |
| | numeric |
| Business URL | 60 character alpha |
| | numeric |

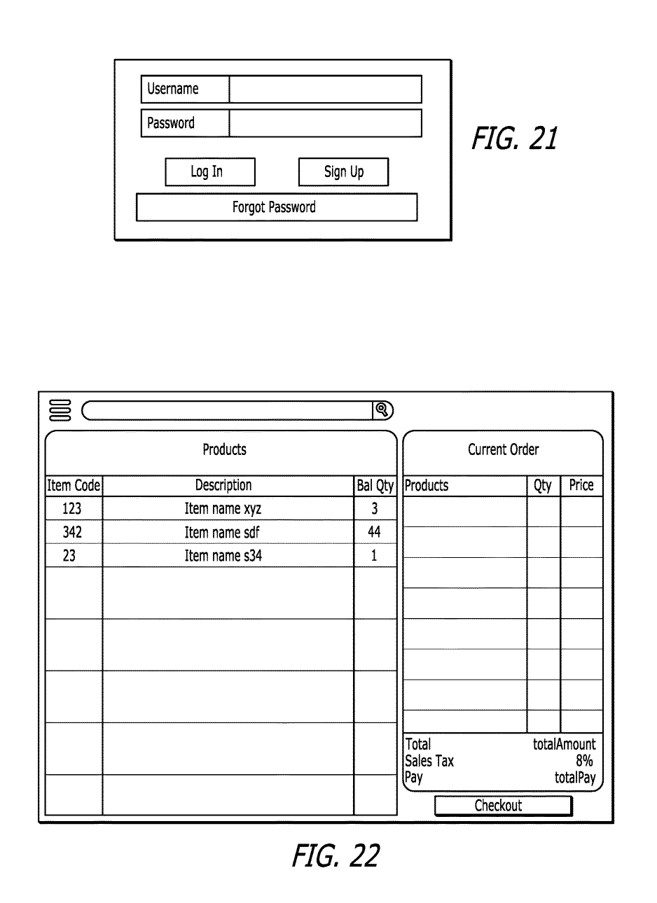

Following are the exemplary steps to purchase marijuana from a marijuana dispensary using the system 100, according to one embodiment. However, the system 100 may be used for purchase and sale of any controlled or restricted substance or product. First, a customer may walk in and select a controlled substance or product to purchase. Second, a clerk enters his user Id and password (as shown in FIG. 21) on the end user terminal 102. In one embodiment, if the clerk has not used the POS 101 for more than 3 minutes (or any amount of time, the clerk may need to log back into the system. The number of minutes it will take before the POS application locks may be defined in the System Setup file. Third, the clerk enters the substance or product information into the system 100. In one embodiment, the clerk selects the item(s) from the list of inventory on the left side of the new sales screen (FIG. 22), or the clerk may enter a product ID. The clerk also has the ability to search for a product by entering a product code or any string of characters for the description field. The POS application may retrieve the details from the Inventory Master and populate the screen. If the selected product is a controlled substance, like a drug, a drug tax rate may be calculated and the clerk may either scan in or enter the RFID number. For a dispensary, the tax rate may be different than a retail store.

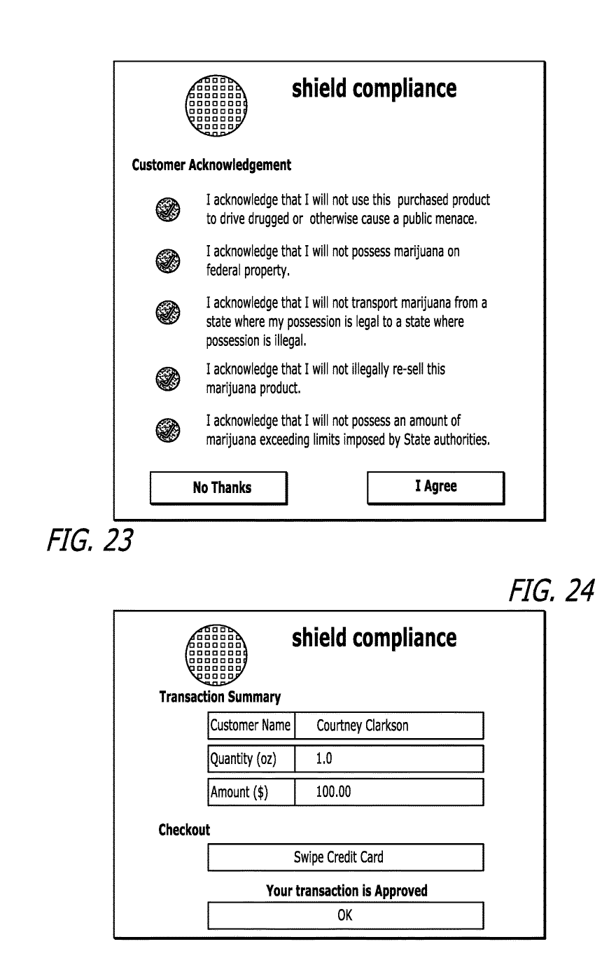

Fourth, a customer acknowledgement screen may be displayed on a display of the end user terminal. The display of the end user terminal may be a touch screen in some embodiments. By way of example only, the purchaser may have to acknowledge some or all of the following statements, also shown in FIG. 23:
“I acknowledge that I will not use this purchased product to drive drugged or otherwise cause a public menace.”
“I acknowledge that I will not possess marijuana on federal property.”
“I acknowledge that I will not transport marijuana from a state where my possession is legal to a state where possession is illegal.”
“I acknowledge that I will not illegally re-sell this marijuana product.”
“I acknowledge that I will not possess an amount of marijuana exceeding limits imposed by state authorities.”

Depending on the regulations, any number or type of acknowledgements may be displayed on the end user terminal to the purchaser. In this embodiment, the customer must click on I AGREE to continue with the purchase.

Sixth, the checkout screen may appear as shown in FIG. 24. In one embodiment, the customer completes the transaction by completing the payment using a debit card (or check) associated with the bank account of the customer registered in the system 100. In another embodiment, the customer may pay using a credit card, cash, or special dispensary card associated with the customer. In other embodiments, only some of the above steps are necessary to complete a transaction.

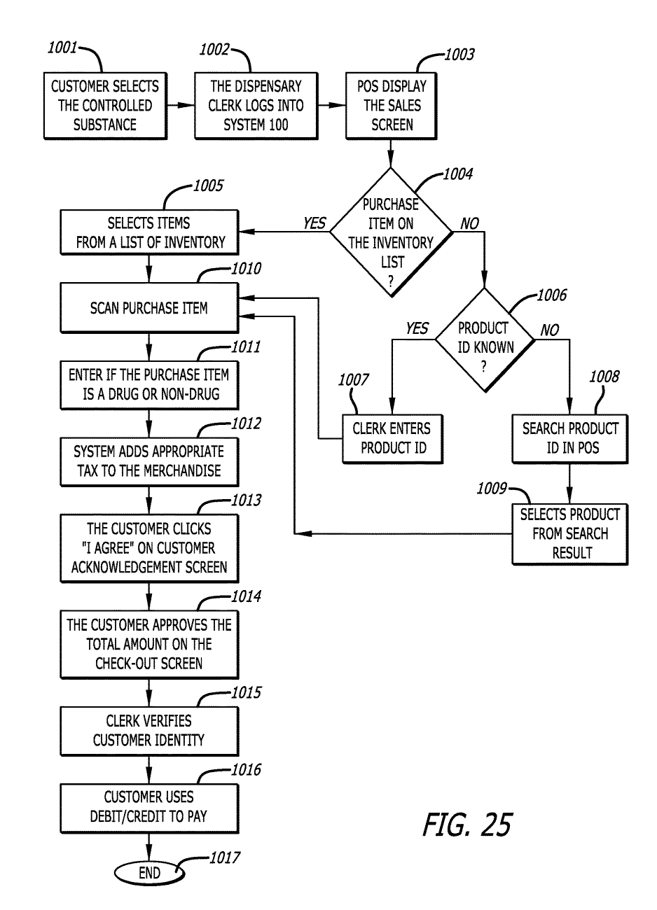

FIG. 25 illustrates a process 1000 flow diagram describing steps to purchase/sell a controlled substance using the system 100, according to one embodiment. By way of example and not by way of limitation, the following example is specific to marijuana dispensaries. However, the system 100 may be used for the purchase and sale of any controlled substance or product. At step 1001, in order to purchase marijuana from a marijuana dispensary, a customer of the system 100 selects a specific marijuana product from the available inventories of the dispensary. Next, at 1002, a clerk of the dispensary logs into the system 100 using his username and password via the POS application 101 running on end user terminal, as shown in FIG. 21. In another embodiment, the clerk may only have to log into the system 100 one time or not at all. Once logged in, at 1003, a sales screen of the system 100 is displayed on the end user terminal 102 via the POS 101. Next, at 1004, the clerk checks in the POS application 101 to determine if the items the customer has selected for purchase are present in the list of inventory from the inventory tab at the top bar of the sales screen of the POS application 101. If the items the customer has selected for purchase are present in the list of inventory, at 1005, the clerk selects the items the customer has selected for purchase from the list of inventory.

In the event the items selected by the customer for purchase are not present in the inventory list, at 1006, the process determines if the product IDs of the items selected by the customer for purchase are known to the clerk or merchant of the dispensary. If so, at 1007, the clerk or the merchant enters the product IDs in the POS application 101 via a virtual keyboard on the touch screen display of the end user terminal 102. However, if the product IDs of the items selected by the customer are not known to the clerk or the merchant user, at 1008, the clerk or the merchant user searches the product IDs by entering any string of characters in the description field of the search tab in the sales screen of the POS application 101. The processor 106 performs a search in the inventory master 108 database for the desired product ID, based on the information provided by the clerk or the merchant in the description field of the search tab. The search results may be displayed on the sales screen. At 1009, the clerk or the merchant user selects the desired items from the search results and enters the product ID of the items in the POS application 101 on the end user terminal 102.

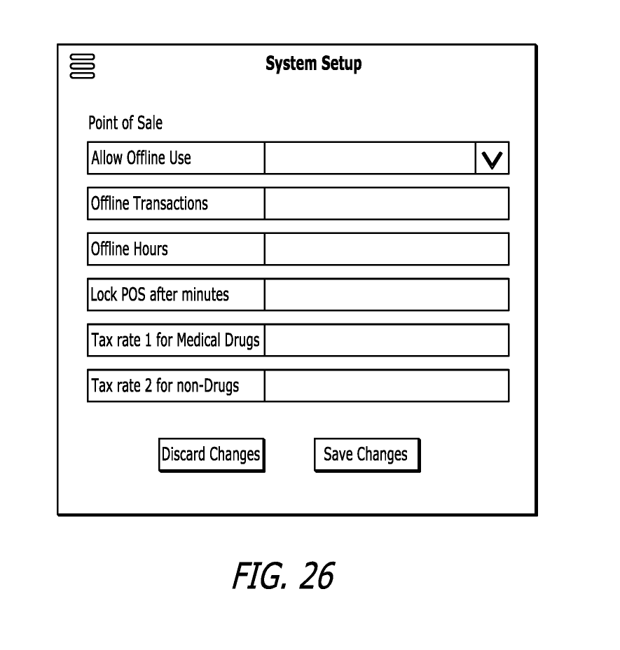

From 1005, 1007 and 1009, the process 1000 continues to 1010. At 1010, the clerk scans each item of the selected merchandise (using a scanner or camera device attached to the end user terminal 102) or enters the RFID number of the selected merchandise in the POS application 101. Next, at 1011, the clerk enters in the POS application 101 the appropriate category (e.g., drug merchandise or non-drug merchandise) of the merchandise, which determines the tax rate applicable to the merchandise. At 1012, the processor 106 retrieves the appropriate tax rate for the drug and non-drug merchandise from the database 104 and adds the appropriate tax rate with the price of the merchandise during the checkout, as shown in FIG. 26.

Next, at 1013, the customer acknowledgement screen may be displayed as shown in FIG. 23. On the acknowledgement screen, the customer clicks on I AGREE. Next, at 1014, the checkout screen appears (as shown in FIG. 24) and the customer approves the total amount on the checkout screen. Next, at 1015, the clerk of the dispensary verifies the identity of the customer. This may be done by scanning the driver's license of the customer using the scanner 110 or taking a picture of the customer using the camera device 111, and then comparing the scanned driver's license or the photograph of the customer with the customer's driver's license and photograph saved in the database 104.

Next, at 1016, the customer completes the transaction by completing the payment using a debit card (or check) associated with the bank account of the customer registered in the system 100. In one embodiment, the customer can also pay using a credit card or cash. The system 100 records the time of purchase to the database 104. At 1017, the process ends. The system may also use a video camera to record the transaction. Such a video may be stored in the database 104.

The following are the exemplary sales rules that may be applied to the customers of the system 100. In one embodiment, if during a purchase and sale transaction of the controlled substance, the processor 106 determines that the dollar amount of the retail transaction is greater than the maximum dollar amount for purchase/sale (e.g., $10,000), as specified in the compliance rules of the dispensary saved in the database 104, the system 100 puts the transaction on hold until the vendor approves the transaction. In another embodiment, the POS application 101 prevents a purchase and sale transaction, if during the transaction of the controlled substance, the processor 106 determines that the age of the customer is less than 21 years (e.g., from the driver's license information of the customer stored on the database 104) or the dollar amount of purchase or sale is below a certain threshold value. The system does not allow any transaction of the controlled substance as a gift.

Also, the system 100 may stop or place on hold a purchase/sale transaction, if during the transaction of the controlled substance, the processor 106 determines that the retail quantity is greater than the purchase quantity limit (e.g. 1 oz.) of controlled substance, as saved in database 104. Likewise, the system 100 stops an out of state purchase/sale transaction if during the transaction of the controlled substance, the processor 106 determines that the retail quantity is greater than the purchase quantity limit of the user (e.g. 0.25 oz.) of controlled substance, as saved in the database 104. These limits may be applied over any period (e.g., a 24-hour period) and subject to search over all dispensaries using system 100. In one embodiment, if customer acknowledgement is not validated, then the system 100 stops or places on hold the transaction. In another embodiment, if the retail transaction is greater than the maximum dispensary sales transaction amount set by bank and/or dispensary, then the system 100 puts the transaction on hold until the merchant user who owns the dispensary approves the transaction. The system 100 sends an alert or message to end user terminal 102, which blocks the POS application 101 from completing the sale.

By way of example, the following are the exemplary purchase rules from the vendor user of the system 100. In one embodiment, if during a purchase transaction between a cultivator or grower and a merchant, the processor cannot verify the identity of the cultivator, and/or the cultivator's cannabis license is not provided to the system 100, the system 100 stops the transaction. The merchant user's identity is verified by the system 100 when the merchant user is successfully logged into the system. The pertinent information from the cultivator's ID is captured using the scanner 110 or camera device 111 attached to the end user terminal 102. The captured information from the cultivator's ID is compared to the information of the cultivator stored in the database 104 of the system 100, to verify the identity of the cultivator. Also, the system 100 stops transaction, if during the transaction of the controlled substance, the processor 106 determines that any one of the merchant or the cultivator is a non-US citizen. Likewise, the system 100 stops transaction, if during the transaction of the controlled substance, the processor 106 determines that the payment to cultivator is requested out of the country. In some embodiments, the system 100 stops, or places on hold a transaction, if during the transaction of the controlled substance, the processor 106 cannot validate the location of the end user system 102. In one embodiment, the system 100 stops a transaction, if during the transaction of the controlled substance, the processor 106 determines that the hours of operations are not met. For example, each transaction may be timestamped, and if the timestamp on the transaction indicates that time of the day is not between 8 am and midnight (set hours of operation), or other appropriate time, then the system 100 will not allow the merchant to complete the transaction. Also, the system 100 stops or places on hold a transaction, if during the transaction of the controlled substance, the processor 106 determines that no RFID of the product is provided to the system 100. The above examples are for explanation only and should not limit the present system and method.

In one embodiment, the POS application 101 in the end user terminal accepts cash, checks, credit card, paypal, mobile payment and the like as payment method for purchase and/or sale of controlled substance. In some embodiments, the dispensaries offer loyalty cards to customers. Using the loyalty card of a dispensary, a returning customer of the dispensary gets discounts on the products he purchases from that dispensary.

In certain embodiment, the system 100 may be used for forensic accounting to verify an audit trail generated by POS 101 of system 100. According to one embodiment the following points may be used to verify the audit trail:

1. The business receives substantially more revenue than may reasonably be expected given the relevant limitations imposed by the state in which it operates.

2. The business receives substantially more revenue than its local competitors or than might be expected given the population demographics.

3. The business is depositing more cash than is commensurate with the amount of marijuana-related revenue it is reporting for federal and state tax purposes.

4. The business is unable to demonstrate that its revenue is derived exclusively from the sale of marijuana in compliance with state law, as opposed to revenue derived from (i) the sale of other illicit drugs (ii) the sale of marijuana not incompliant with state law, or (iii) other illegal activity.

5. The business makes cash deposits or withdrawals over a short period of time that are excessive relative to local competitors or the expected activity of the business.

6. Deposits apparently structured to avoid Currency Transaction Report (“CTR”) requirements.

7. Rapid movement of funds, such as cash deposits followed by immediate cash withdrawals.

8. Deposits by third parties with no apparent connection to the accountholder.

9. Excessive commingling of funds with the personal account of the business's owner(s) or manager(s), or with accounts of seemingly unrelated businesses.

10. Individuals conducting transactions for the business appear to be acting on behalf of other, undisclosed parties of interest.

11. Financial statements provided by the business to the financial institution are inconsistent with actual account activity.

12. A surge in activity by third parties offering goods or services.

13. A marijuana-related business engages in international or interstate activity, including by receiving cash deposits from locations outside the state in which the business operates, making or receiving frequent or large interstate transfers, or otherwise transacting with persons or entities located in different states or countries.

In one embodiment, the system 100 may be used to verify the licensing and operations of the users. In such embodiment, the system 100 may use the following points to verify the licensing operation:

1. The business is unable to produce satisfactory documentation or evidence to demonstrate that it is duly licensed and operating consistently with state law.

2. The business is unable to demonstrate the legitimate source of significance outside investments.

3. A customer seeks to conceal or disguise involvement in marijuana-related business activity. For example, the customer may be using a business with a non-descript name (e.g., “consulting, “holding” or “management”).

4. Review of publicly available sources and databases about the business, its owner(s), manager(s), or other related parties, reveal negative information.

5. The business, its owner(s) manager(s) or other related parties are, or have been, subject to an enforcement action by the state or local authorities.

6. The owner(s) or manager(s) of a marijuana-related business reside outside the state in which the business is located.

7. A marijuana-related business is located on federal property or the marijuana sold by the business was grown on federal property.

8. A marijuana-related business's proximity to a school is not compliant with state law.

9. A marijuana-related business purporting to be a “non-profit” is engaged in commercial activity inconsistent with that classification.

By way of example only, and not by way of limitation, the system 100 may have the following system requirements (e.g., these specifications and models are given as examples and not absolute requirements).

### Back End:

Windows Server 2012+ and Linux 2.4+ operating systems in 32-bit or 64-bit modes.
MySQL Database
2 gigahertz (GHz) or faster 32-bit (x86) or 64-bit (x64) processor
4 gigabyte (GB) RAM (32-bit) or 8 GB RAM (64-bit)
32 GB available hard disk space (32-bit) or 64 GB (64-bit)
Broadband Internet Connection

### End User:

Mobile Devices:
   a. iOS (v7+)
      i. iPhone 5 or later
      ii. iPad 3 or later
   b. Android (v4+)
      i. Samsung Galaxy S3 or later
   c. Windows Phone (v8+)
      i. Nokia Lumia Icon or later

Various aspects of the systems, methods, functions, steps, features and the like corresponding thereto disclosed herein may be implemented on one or more computer systems using hardware, software, firmware, circuits, or combinations thereof. Hardware, software, firmware, and circuits respectively refer to any hardware, software, firmware, or circuit component. Computer systems referred to herein may refer to any computing device and vice versa (e.g., smart phone, mobile computing device, personal data assistant, tablet computer, laptop computer, desktop computer, other computing device, and the like). For example, each computer system or computing device in the systems described herein or any embodiment of a system disclosed herein may utilize one or more of the following components: a single-core or multi-core hardware processor (e.g., central processing unit or graphics processing unit) on which software instructions are executed (e.g., instructions corresponding to an operating system, an application program, an interpreter such as a virtual machine, or a compiler); a memory associated with and in connection with the hardware processor such as cache or other system memory that stores software instructions or other data that the hardware processor may access for processing; an input device (e.g., mouse, keyboard, touchscreen, and the like); an output device (e.g., display, touchscreen, printer, and the like); a network or communication interface that enables the computer system to communicate over a network or communication protocol; an application program having corresponding software instructions that are executable by a hardware processor. Connections between different computer systems and connections between different computer system components may be wired or wireless.

Virtualization computing techniques, cloud computing techniques, web application/web site computing techniques, traditional and adaptive streaming techniques, and other computing techniques may be implemented by any embodiment of a system disclosed herein to enable and/or enhance the teachings described herein. For example, in a cloud computing embodiment, one or more servers (i.e., one or more computer systems) may store and execute software instructions corresponding to an application program based on input data received from client devices. In response to the input data received, the application program is executed accordingly, which results in graphical data being processed and output to the client devices for display on a display such as a touch screen on a smart phone or tablet computer.

As another example, in a web application or website embodiment, data representative of a user input may be transmitted to a server (i.e., a computer system) hosting the website for processing and storage in memory. In an application program embodiment, the application may be stored and executed locally on a user's computer system. In other embodiments, one or more components of the application program may be stored and executed on a server and the user's computer system. For example, a user may download the application program from an app store for an Android computing device, Blackberry computing device, Apple computing device, Windows computing device, Samsung computing device, other computing device, and the like. Execution of the application program on the user's computing device may require that the device transmit and receive data to and from one or more computing devices such as a server or other user's computing device. For example, an application may be downloaded from a server to a mobile device. Upon installation, the mobile device may communicate with a server.

One or more embodiments of the systems disclosed herein may be located on (i.e., processed, stored, executed, or the like; or include one or more hardware or software components) a single computer system or may be distributed among a plurality of computer systems attached by one or more communication networks (e.g., internet, intranet, a telecommunications network, and the like). One or more components of a computer system may be distributed across one or more computer systems in communication with the computer system over a communication network. For example, in some embodiments, the systems disclosed herein may utilize one or more servers (i.e., one or more computer systems dedicated for a particular purpose in the system) that may be dedicated to serve the needs of one or more other computer systems or components across a communication network and/or system bus. The one or more servers may provide a central processing location for one or more aspects of the systems disclosed herein.

Again, various embodiments of the systems, methods, function, and steps corresponding thereto disclosed herein may be implemented on one or more computer systems using hardware, software, firmware, or combinations thereof. Those of ordinary skill in the art will appreciate that one or more circuits and/or software may be used to implement the system and methods described herein. Circuits refer to any circuit, whether integrated or external to a processing unit such as a hardware processor. Software refers to code or instructions executable by a computing device using any hardware component such as a processor to achieve the desired result. This software may be stored locally on a processing unit or stored remotely and accessed over a communication network.

As disclosed herein, a processor or hardware processor may refer to any hardware processor or software processor. A software processor may include or otherwise constitute an interpreter that is executed by a corresponding hardware processor. A computer system according to any embodiment disclosed herein is configured to perform any of the described functions related to the various embodiments of the systems disclosed herein.

As disclosed herein, any method, function, step, feature, or result may be considered a module that may include software instructions that cause, when executed by a computing device, the desired method, function, step, feature, or result. Executed by a computing device includes execution by any hardware component (e.g., CPU, GPU, network interface, integrated circuits, other hardware components, and the like) of the computing device such as a hardware processor. Any module may be executed by a computing device (e.g., by a processor of the computing device). Any method, function, step, feature, result, and the like disclosed herein may be implemented by one or more software modules whether explicitly described or not. Individual components within a computing device may work together to accomplish a desired method, function, step, feature, or result. For example, a computing device may receive data and process the data. A simple example would be that a network interface receives the data and transmits the data over a bus to a processor.

Various embodiments of the systems disclosed herein may be implemented as software executing in a computer system. The computer system may include a central processing unit (i.e., a hardware processor) connected to one or more memory devices, a graphical processing unit, input devices such as a mouse and keyboard, output devices such as speakers and a display, a network interface to connect to one or more other computer systems (e.g., one or more computer systems configured to provide a service such that function as a database), an operating system, a compiler, an interpreter (i.e., a virtual machine), and the like. The memory may be used to store executable programs and data during operation of the computer system. The executable programs may be written in a high-level computer programming language, such as Java or C++. Of course, other programming languages may be used since this disclosure is not limited to a specific programming language or computer system. Further, it is to be appreciated that the systems and methods disclosed herein are not limited to being executed on any particular computer system or group of computer systems.

Some methods, functions, steps, or features have been described as being executed by corresponding software by a processor. It is understood than any methods, functions, steps, features, or anything related to the systems disclosed herein may be implemented by hardware, software (e.g., firmware), or circuits despite certain methods, functions, steps, or features having been described herein with reference to software corresponding thereto that is executable by a processor to achieve the desired method, function, or step. It is understood that software instructions may reside on a non-transitory medium such as one or more memories accessible to one or more processors in the systems disclosed herein. For example, where a computing device receives data, it is understood that the computing device processes that data whether processing the data is affirmatively stated or not. Processing the data may include storing the received data, analyzing the received data, and/or processing the data to achieve the desired result, function, method, or step. It is further understood that input data from one computing device or system may be considered output data from another computing device or system, and vice versa. It is yet further understood that any methods, functions, steps, features, results, or anything related to the systems disclosed herein may be represented by data that may be stored on one or more memories, processed by one or more computing devices, received by one or more computing devices, transmitted by one or more computing devices, and the like.

The various embodiments and examples described herein are provided by way of illustration only and should not be construed to limit the claimed invention, nor the scope of the various embodiments and examples. Those skilled in the art will readily recognize various modifications and changes that may be made to the claimed invention without following the example embodiments and applications illustrated and described herein, and without departing from the true spirit and scope of the claimed invention, which is set forth in the following claims. In addition, various embodiments may be combined. Therefore, reference to an embodiment, one embodiment, in some embodiments, in other embodiments, and the like does not preclude one or more methods, functions, steps, features, results, hardware implementations, or software implementations of different embodiments from being combined. Further, reference to an embodiment, one embodiment, in some embodiments, in other embodiments, examples, and the like provides various aspects that may or may not be combined with those of one or more different embodiments and/or examples.

What is claimed:

1. A protection system for tracking and securing the purchase and sale of a controlled substance, the system comprising:
a network;
a database that stores information of a plurality of customers, information regarding each customer is stored in an individual account, the database further stores the information regarding government regulations on purchase and sale of the controlled substance;
a plurality of end user terminals at individual shops to record transactions of the controlled substance, the plurality of end user terminals are in communication with the database over the network; and
a server in communication with the database and the end user terminals over the network, the server including a compliance reporting system, the compliance reporting system executes instructions to compare in real time information about one customer and information concerning the purchase of the controlled substance on one of the plurality of end user terminals to information stored in the database regarding the government regulations and the customer, wherein the compliance reporting system prevents the purchase of the controlled substance based on the comparison.

2. The protection system of claim 1, wherein the end user terminal is a mobile device.

3. The protection system of claim 2, wherein the customer information is entered via a point of sale software application running on the mobile device using a processor and a memory of the mobile device.

4. The protection system of claim 3, wherein the customer information includes a copy of an identification document.

5. The protection system of claim 3, wherein the customer information includes biometric information.

6. The protection system of claim 3, wherein the end user terminal includes a local memory, and information on transactions of the controlled substance are stored in the local memory of the end user terminal.

7. The protection system of claim 6, wherein the local database of the end user terminal synchronizes with the database to store updated information from the end user terminal.

8. The protection system of claim 1, further comprising an inventory database storing information regarding available inventories of the controlled substance at the individual shops.

9. The protection system of claim 1, wherein the compliance reporting system records every purchase and sale of the controlled substance made at the individual shops in the database.

10. The protection system of claim 9, wherein the compliance reporting system accesses the purchase records of the individual shops for anti-money laundering reporting to the government.

11. The protection system of claim 8, wherein the compliance reporting system stores compliance rules for the purchase and sale of the controlled substance.

12. The protection system of claim 11, wherein the compliance rules include information regarding maximum dollar amount for each transaction, maximum number of transactions allowed per customer, or quantity limit of controlled substance.

13. The protection system of claim 12, wherein if the compliance reporting system determines that the dollar amount of the retail transaction is greater than the maximum dollar amount for the transaction, as specified in the compliance rules saved in the database, the compliance reporting system places the transaction on hold.

14. The protection system of claim 12, wherein the compliance reporting system stops a transaction, if the compliance reporting system determines that the retail quantity is greater than the purchase quantity limit of the controlled substance.

15. The protection system of claim 1, wherein the compliance reporting system stops a transaction, if the compliance reporting system determines that the dollar amount of the transaction is under a threshold level.

16. A method for tracking and securing the purchase and sale of a controlled substance, the method comprising:
storing in a database information of a plurality of customers and information regarding government regulations on purchase and sale of the controlled substance;
recording transactions of the controlled substance on an end user terminal at an individual shop, the end user terminal is in communication with the database over a network; and
comparing information about one customer and information concerning the purchase of the controlled substance on the end user terminal to information stored in the database regarding the government regulations and the customer with a server in communication with the database and the end user terminal over the network, wherein the compliance reporting system prevents the purchase of the controlled substance based on the comparison.

17. The method of claim 16, wherein comparing information about one customer and information concerning the purchase of the controlled substance on the end user terminal to information stored in the database regarding the government regulations and the customer with a server is done in real time.

18. The method of claim 16, further comprising verifying customer identification.

19. The method of claim 16, further comprising synchronizing a local database of the end user terminal with the database to store updated information from the end user terminal.

20. The method of claim 16, further comprising accessing the purchase records of the individual dispensaries for anti-money laundering reporting to the government.
